(19) United States
(12) Patent Application Publication
(10) Pub. No.: US 2025/0344745 A1
(43) Pub. Date: Nov. 13, 2025

(54) ADJUSTABLE PLATEN ASSEMBLY

(71) Applicant: Frito-Lay North America, Inc., Plano, TX (US)

(72) Inventors: Bradley Scott Shepard, Wylie, TX (US); Baqar Abbas, Rugby (GB); Scott James Fagan, Dallas, TX (US); Steven Jonathan Clarke, Marlow (GB); Thomas Gary Sutherland Miles, Wheathampstead (GB); Xavier Jean Rene Herpe, Cambridge (GB); Joshua Andrew Burton-Brown, Hertford (GB); Anna Elinor Parker, Cambridge (GB)

(21) Appl. No.: 19/201,842

(22) Filed: May 7, 2025

Related U.S. Application Data
(60) Provisional application No. 63/646,240, filed on May 13, 2024.
(60) Provisional application No. 63/704,280, filed on Oct. 7, 2024.
(60) Provisional application No. 63/771,145, filed on Mar. 13, 2025.

(51) Int. Cl. A23P 30/32; A23P 30/10; B30B 1/02

(52) U.S. Cl. CPC A23P 30/32; A23P 30/10; B30B 1/02

(57) ABSTRACT

A compression head assembly for making a compressed product comprises a first platen assembly, a first actuator, and a first collar assembly. The first platen assembly includes a first frame and a first punch assembly having a first punch to compress and heat raw ingredients. The first actuator is coupled with the first frame and the first punch assembly to move selectively the first punch assembly relative to the first frame. The first collar assembly is coupled with the first actuator to stop the first actuator from moving the first punch assembly past a first predetermined location relative to the first platen assembly.

### CROSS REFERENCE TO RELATED APPLICATIONS

This application claims priority to and the benefit of U.S. Provisional Patent Application No. 63/646,240, filed 13 May 2024, U.S. Provisional Patent Application No. 63/704,280, filed 7 Oct. 2024, and U.S. Provisional Patent Application No. 63/771,145, filed 13 Mar. 2025, the disclosures of which are now expressly incorporated herein by reference.

### BACKGROUND

The present invention generally relates to an apparatus for compressing, cooking, and expanding food product and a method of performing the same.

In the past few decades, a strong trend emerged in the food industry to develop more nutritious and healthier snacks. Health-conscious consumers increasingly demand food products that include lower fat content, offer more balanced amounts of protein and carbohydrates, or are generally more health-promoting than traditional snacks such as candies, chips, crackers, and the like. As a result, the food industry has attempted to tackle the challenges of making wholesome snack food products out of conventional or alternative ingredients and with less fat or sugar while maintaining or improving the taste and texture of such food products.

In the trend of healthy snacking, puffed snacks have become more and more popular due to their inherent lightness, crispy texture, and ability to accommodate flavoring. As one example, automatic machines for the making of rice crackers and similar puffed or popped granular cakes by pressure-baking and expanding a food-starch containing material in a heated mold are known from the prior art to exist in a number of distinct machine variants. It remains a desire to produce such puffed snacks economically while providing batch uniformity and consistency.

### SUMMARY

Aspects and embodiments of the described apparatus for making expanded food product and methods of making product using the described apparatus are set out in the appended claims. These and other aspects and embodiments of the described apparatus for making expanded food product and methods of making such product are also described below.

According to an aspect of the present disclosure, a compression head assembly for making a compressed product includes a first platen assembly and a second platen assembly. The first platen assembly includes a compression head frame and a first punch assembly coupled with the compression head frame. The second platen assembly includes a moving frame coupled with the compression head frame and a second punch assembly coupled with the moving frame. At least one of the first punch assembly is movable relative to the compression head frame or the second punch assembly is movable relative to the moving frame to apply a compressive force between the first punch assembly and the second punch assembly to provide the compressed product. The moving frame is movable relative to the compression head frame between a lowered position in which the second punch assembly is proximal to the first punch assembly and a raised position in which the second punch assembly is distal to the first punch assembly to increase accessibility between the first platen assembly and the second platen assembly.

In some embodiments, the compression head frame and the moving frame are interlocked in the lowered position to block movement of the compression head frame relative to the moving frame in response to a compressive force applied by the first punch assembly and the second punch assembly acting on compression head frame.

In some embodiments, the compression head assembly includes a moving frame actuator unit and a locking assembly. The moving frame actuator may be coupled with the compression head frame and the moving frame and configured to move selectively the moving frame relative to the compression head frame to cause the second platen assembly to move relative to the first platen assembly and increase accessibility to the first platen assembly and the second platen assembly. The locking assembly may include an actuating assembly and a locking block. The actuating assembly may be configured to selectively translate the locking block between a retracted position in which the locking assembly is configured to allow the moving frame actuator unit to move the second platen assembly relative to the compression head frame and an extended position in which the locking assembly is configured to block the second platen assembly from moving relative to the compression head frame. The locking block may be coupled to the actuator assembly such that the locking block can slide relative to the lock actuator in a direction of movement of the moving frame.

In some embodiments, the compression head assembly includes a first tension rod extending between a vertical support and a base portion on a first side of the compression head frame to apply a force to the compression head assembly that counters deflection caused by the compressive force during operation of the compression head assembly and allow the first punch assembly and the second punch assembly to be parallel with each other during operation.

According to another aspect of the present disclosure, a compression head assembly for making a compressed product includes a first platen assembly, a first actuator, and a first collar assembly. The first platen assembly includes a first frame and a first punch assembly having a first punch to compress and heat raw ingredients. The first actuator is coupled with the first frame and the first punch assembly to move selectively the first punch assembly relative to the first frame. The first collar assembly is coupled with the first actuator to stop the first actuator from retracting the first punch assembly past a first predetermined location relative to the first platen assembly.

According to another aspect, a compression head assembly for making a compressed product comprises a first platen assembly that includes a first frame and a first punch assembly having a first punch to compress and heat raw ingredients. The compression head assembly may comprise a first actuator coupled with the first frame and the first punch assembly to move selectively the first punch assembly relative to the first frame.

In some embodiments, the compression head assembly comprises a first collar assembly coupled with the first actuator to stop the first actuator from moving the first punch assembly past a first predetermined location relative to the first platen assembly. The first frame may include a support frame and a first ring plate coupled with the support frame. The compression head assembly may comprise the first frame houses the first punch assembly and is coupled with the first actuator to allow the first actuator to move the first punch assembly relative to the first ring plate.

In some embodiments, the first predetermined location corresponds to an outer surface of the first ring plate. The first collar assembly may be coupled to the first actuator to stop the first actuator from retracting the first punch assembly past an outer surface of the first ring plate. The first ring plate may include a first ring hole that receives the first punch therein to guide movement of the first punch as the first actuator moves the first punch assembly. The predetermined location may correspond to a position of the first punch assembly where an end surface of the first punch is flush with the outer surface of the first ring plate.

In some embodiments, the first ring plate includes a first ring hole that receives the first punch therein to guide movement of the first punch as the first actuator moves the first punch assembly. The predetermined location may correspond to a location within the first ring plate to stop the first actuator from completely retracting the first punch from the first ring hole. The first collar assembly may be configured to set a depth of a cavity formed by the first ring plate and the first punch.

In some embodiments, the compression head assembly comprises a second platen assembly that includes a moving frame coupled with the first frame and a second punch assembly having a second punch to compress and heat the raw ingredients. The first punch assembly may be configured to move selectively relative to the first frame and/or the second punch assembly is configured to move selectively relative to the moving frame. The second punch assembly and the first punch assembly may be configured to compress and heat the raw ingredients therebetween to provide the compressed product. The compression head assembly may comprise a moving frame actuator unit coupled with the first frame and the moving frame.

In some embodiments, the moving frame actuator is configured to move selectively the moving frame relative to the first frame to cause the second platen assembly to move relative to the first platen assembly and increase accessibility for cleaning the first platen assembly and the second platen assembly. The compression head assembly may comprise a second actuator coupled with the moving frame and the second punch assembly to move selectively the second punch assembly relative to the moving frame.

In some embodiments, the compression head assembly comprises a second collar assembly coupled with the second actuator to stop the second actuator from moving the second punch assembly past a second predetermined location relative to the second platen assembly.

In some embodiments, the first frame includes a support frame and a first ring plate coupled with the support frame. The first frame may house the first punch assembly and may be coupled with the first actuator to allow the first actuator to move the first punch assembly relative to the first ring plate. The predetermined location may correspond to a location within the first ring plate to stop the first actuator from completely retracting the first punch from the first ring hole.

In some embodiments, the moving frame includes a second platen carriage and a second ring plate coupled with the second platen carriage. The second platen carriage may house the second punch assembly and may be coupled with the second actuator to allow the second actuator to move the second punch assembly relative to the second platen carriage. The second ring plate may include a second ring hole that receives the second punch therein to guide movement of the second punch as the second actuator moves the second punch assembly.

In some embodiments, the predetermined location corresponds to location where an outer surface of the second punch assembly is flush with an outer surface of the second ring plate. The cavity may be configured to receive the raw ingredients compressed between the first punch and the second punch.

In some embodiments, the predetermined location is configured to position an outer surface of the second punch flush with a bottom surface of the second ring plate such that the second ring plate and the second punch form a continuous, flat surface.

In some embodiments, the first collar assembly is configured to be removable from the first actuator to increase a maximum retraction distance of the first punch.

In some embodiments, the first collar assembly is coupled to the first actuator such that a location of the first collar assembly on the first actuator can be adjusted to change the predetermined location. The first collar assembly may include a collar and a locking nut. The locking nut may be coupled to the first actuator to change a distance between the first collar assembly and the first punch assembly to change the predetermined location.

In some embodiments, the compression head assembly comprises a controller having a memory with instructions stored therein and at least one processor configured to perform the instructions. The controller may be programmed to operate the compression head assembly in a clean mode in which the controller instructs the second actuator to move the second punch assembly such that the second punch extends into the second ring plate.

In some embodiments, in the clean mode, the controller instructs the first actuator to move the first punch assembly such that the first punch extends into the first ring plate. In the clean mode, the second collar assembly may cause a food contact surface of the second punch to be generally flush with the lower surface of the second ring plate.

In some embodiments, the compression head assembly comprises a controller having a memory with instructions stored therein and at least one processor configured to perform the instructions. The controller may be programmed to operate the compression head assembly in a cook mode in which the controller instructs the second actuator to move the second punch assembly such that the second punch extends into the first ring plate. In the cook mode, the controller may instruct the first actuator to move the first punch assembly such that the first punch extends into the first ring plate to compress and heat the compressed product.

According to another aspect, a method of operating a compression head assembly adapted to make a compressed product comprises extending, via a first actuator, a first punch partway into a first ring hole. The method may comprise compressing raw ingredients by extending a second punch, via a second actuator, relative to a second platen frame towards the first punch. The method may comprise translating the second punch through a corresponding second ring hole formed in a second ring plate and into the first ring hole formed in a first ring plate.

In some embodiments, the method comprises cooking the raw ingredients with the first punch and the second punch while the raw ingredients are compressed to provide the compressed product. The method may comprise moving the second punch relative to the second ring plate a predetermined distance set by a collar assembly coupled to the second actuator such that a food contact surface of the second punch is generally flush with a surface of the second ring plate.

### BRIEF DESCRIPTION OF THE DRAWINGS

The foregoing aspects and many of the attendant advantages of the present technology will become more readily appreciated by reference to the following Description, when taken in conjunction with the accompanying simplified drawings of exemplary embodiments. The illustrative, schematic drawings, briefly described below, are not to scale, are presented for case of explanation and do not limit the scope of the inventions recited in the accompanying claims.

FIG. 1 is a perspective view of a compression head assembly in accordance with the present disclosure;

FIG. 2 is a diagrammatic view the compression head assembly of FIG. 1.

FIG. 3 is a perspective view of a rear of the compression head assembly of FIG. 1.

FIG. 4 is a perspective view of the bottom platen assembly included in the compression head assembly of FIG. 1 with the top platen assembly removed to reveal features of the bottom platen assembly.

FIG. 5 is a perspective view of a bottom punch assembly included in the bottom platen assembly of FIG. 4.

FIG. 6 is a perspective view of a top platen assembly included in the compression head assembly of FIG. 1.

FIG. 7 is a perspective view of the top platen assembly of FIG. 6 with the top punch assembly removed to reveal features of the top platen assembly.

FIG. 8 is a perspective view of the top punch assembly included in the top platen assembly of FIG. 6.

FIG. 9A is an elevation view of the compression head assembly of FIG. 1 showing the bottom punch assembly in a lowered position to receive raw ingredients from the feed system.

FIG. 9B is a sectional view of the compression head assembly of FIG. 1 showing the tab of the upper platen assembly interlocked with an opening of the lower platen assembly.

FIG. 10 is an elevation view of the compression head assembly similar to FIG. 9A showing the top and bottom punch assemblies compressing and heating the raw ingredients to produce the food product.

FIG. 11 is an elevation view of the compression head assembly similar to FIG. 10 after the food product is produced showing the bottom punch assembly raised to position the food products for ejection.

FIG. 12 is an elevation view of the front of the compression head assembly of FIG. 1.

FIG. 13 is an elevation view of the compression head assembly of FIG. 1 showing a collar assembly of the upper platen assembly.

FIG. 14 is a sectional view of the compression head assembly of FIG. 13 showing the collar assembly on the upper platen assembly.

FIG. 15 is an elevation view of the compression head assembly of FIG. 1 showing a collar assembly of the lower platen assembly.

FIG. 16 is a sectional view of the compression head assembly of FIG. 15 showing the collar assembly on the lower platen assembly.

FIG. 17A is an elevation view of the compression head assembly of FIG. 1 showing the compression head assembly in an intermediate orientation with the locking assembly in an extended position and the top platen assembly in a first lowered position.

FIG. 17B is an elevation view of the compression head assembly of FIG. 17A showing the compression head assembly in a locked orientation with the locking assembly in the extended position and the top platen assembly in a second lowered position.

FIG. 18A is a section view of the compression head assembly of FIG. 17A showing the compression head assembly in the intermediate orientation.

FIG. 18B is a section view of the compression head assembly of FIG. 17B showing the compression head assembly in the locked orientation.

FIG. 19 is a perspective view of the top platen assembly included in the compression head assembly of FIG. 6, showing the tab extending from a lower surface of the top platen assembly.

FIG. 20 is an elevation view of the compression head assembly of FIG. 1 showing the compression head assembly in the intermediate position.

FIG. 21 is an elevation view of the compression head assembly of FIG. 20 showing the compression head assembly in the locked orientation.

FIG. 22 is an elevation view of the compression head assembly of FIG. 20 showing the compression head assembly in an unlocked orientation with the locking assembly in a retracted position and the top platen assembly lowered.

FIG. 23 is an elevation view of the compression head assembly of FIG. 1 showing the compression head assembly in the unlocked orientation with the locking assembly in the retracted position and the top platen assembly raised.

FIG. 24 is a section view of the compression head assembly of FIG. 1 showing the top platen lowered and the tab and opening interlocked.

FIG. 25 is a detail section view of the compression head assembly of FIG. 24 with the top and bottom punch assemblies removed, showing the tab of the top platen assembly inserted into the groove of the bottom platen assembly.

FIG. 26 is an elevation view of the compression head assembly of FIG. 1 being cleaned by first and second wipers.

FIG. 27 is an elevation view of the compression head assembly of FIG. 1 being cleaned by a laser head unit.

FIG. 28 is a perspective view of an apparatus for making expanded food product in accordance with the present disclosure, the apparatus including a plurality of the compression head assemblies of FIG. 1.

FIG. 29 is a diagrammatic view of a method for making the expanded food product in accordance with the present disclosure.

### DETAILED DESCRIPTION OF THE DRAWINGS

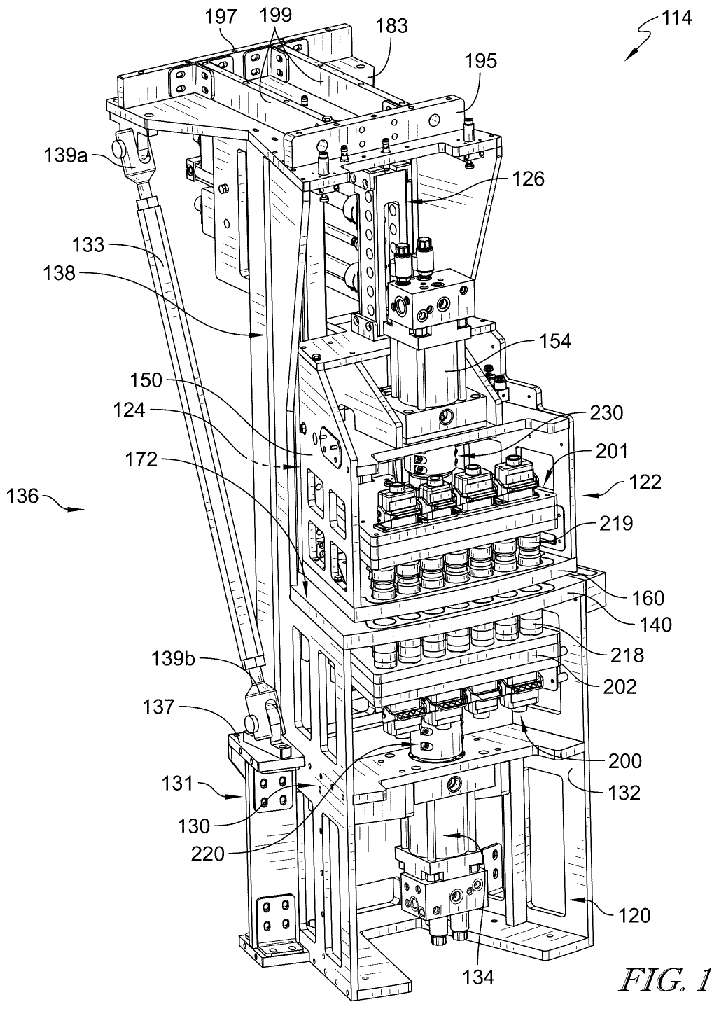

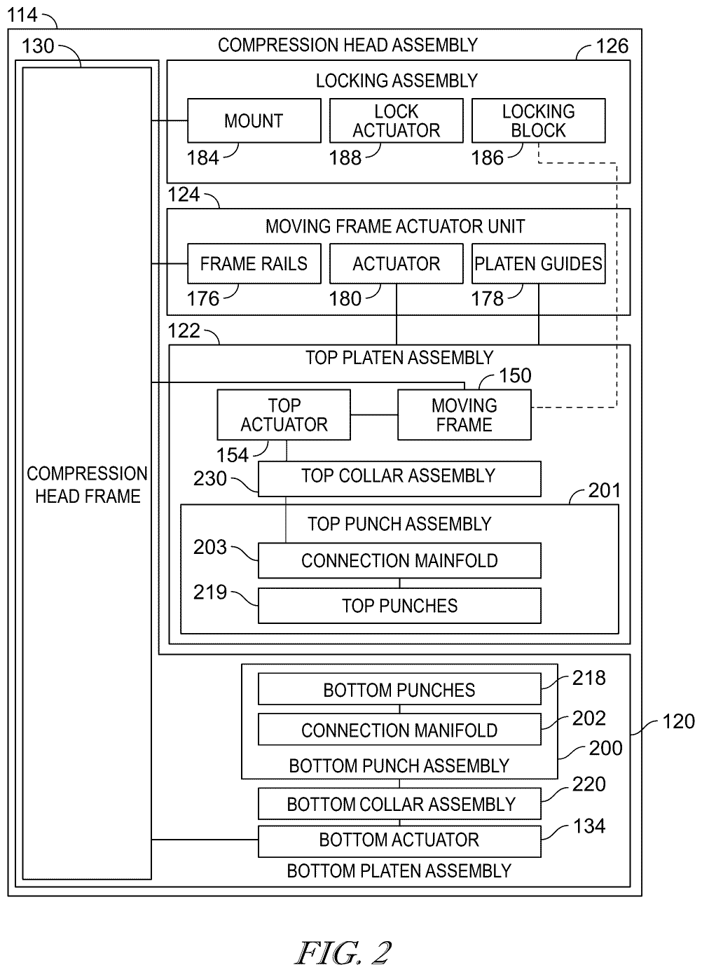

FIGS. 1 and 2 depict a compression head assembly 114 in accordance with the present disclosure. The compression head assembly 114 includes a bottom platen assembly 120, a top platen assembly 122, a moving frame actuator unit 124, and a locking assembly 126. The bottom platen assembly 120 and the top platen assembly 122 cooperate to receive raw ingredients 12 from a feed system and compress, cook, and allow expansion of the raw ingredients 12 to provide expanded food product 14. In some embodiments, the compression head assembly 114 may be used for compressing and/or heating other materials such as metals and polymers.

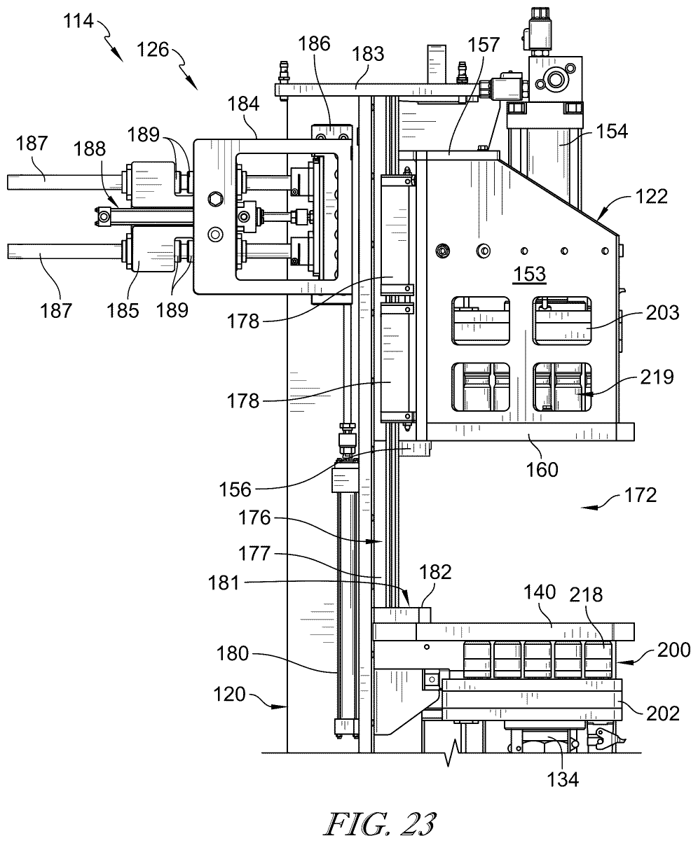

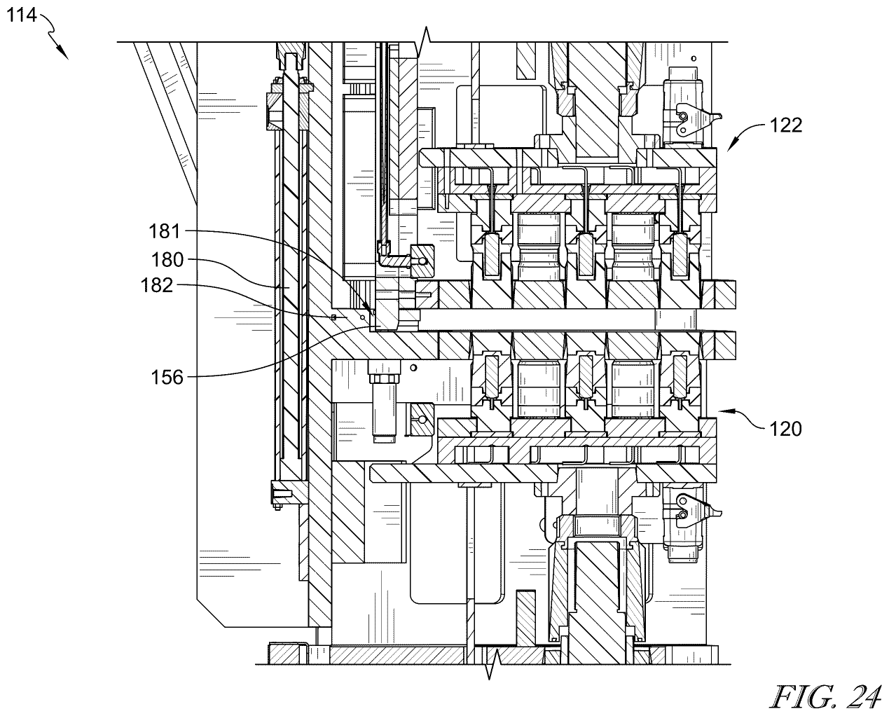

The top platen assembly 122 is movable selectively relative to the bottom platen assembly 120 to allow greater access between the bottom platen assembly 120 and the top platen assembly 122 for cleaning or maintenance as suggested in FIGS. 23, 26, and 27. The size of the space in the raised position may be, for example, at least 200 mm apart. In some embodiments, the size of the space in the raised position may be 500 mm apart. As will be described in greater detail below, the moving frame actuator unit 124 and the locking assembly 126 cooperate to move and block movement, selectively, of the top platen assembly 122 relative to the bottom platen assembly 120 during compression for example to distribute the force loads through the compression head assembly 114. In the illustrative embodiments, the compression head assemblies 114 are configured to act as a C-frame press, allowing for relatively greater accessibility between the top platen assembly 122 and the bottom platen assembly 120 than, for example, an H-frame press. The configuration of the C-frame shaped structure of the compression head assemblies 114 allow for different components of the apparatus 10 to move in and out from between the top platen assembly 122 and the bottom platen assembly 120 as discussed herein.

As depicted in FIGS. 1, 2, 15 and 16, the bottom platen assembly 120 includes a compression head frame 130, a bottom punch assembly 200, a bottom actuator 134, and a bottom collar assembly 220. The compression head frame 130 provides a rigid support structure for the compression head assembly 114 during compression of ingredients 12 or other material by the compression head assembly 114. The bottom punch assembly 200 is configured to move relative to the compression head frame 130 and confront a top punch assembly 201 included in the top platen assembly 122 to compress, cook, and allow expansion of the raw ingredients 12 there between. The bottom actuator 134 is coupled with the compression head frame 130 and the bottom punch assembly 200 and configured to move selectively the bottom punch assembly 200 relative to the compression head frame 130. In the illustrative embodiment, the bottom actuator 134 includes a bottom piston 144 coupled to the bottom punch assembly 200 via a bottom connection flange 145. The bottom connection flange 145 is attached to a bottom surface 209 of the punch assembly 200. In some embodiments, the bottom punch assembly 200 remains fixed relative to the compression head frame 130 and the bottom actuator 134 may be omitted. In such embodiments, the top platen assembly 122 may perform the compression movements and apply force to the static bottom punch assembly 200. In some embodiments, the top punch assembly remains fixed and the bottom platen assembly 120 may perform the compression movements and apply force.

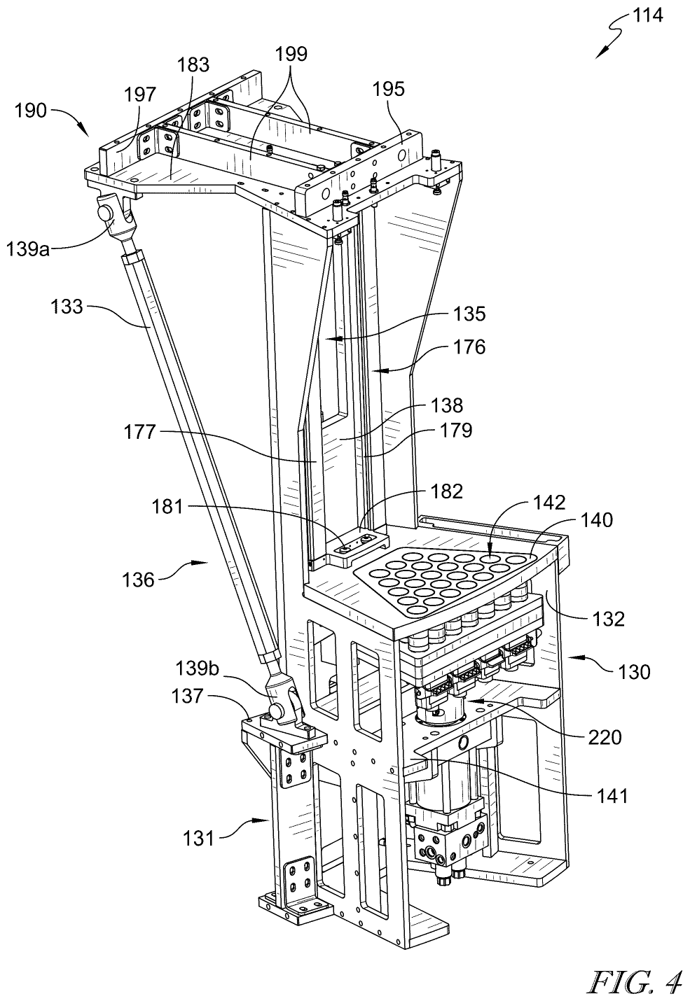

As depicted in FIG. 4, the compression head frame 130 includes a support frame 132, a vertical support 138, and a bottom ring plate 140 coupled with the support frame 132. The support frame 132 may be stationary relative to ground or may be arranged for movement along a path to provide a food production line. The support frame 132 includes a lower portion for receiving the bottom punch assembly 200 and the bottom actuator 134. An upper portion of the support frame 132 forms the vertical support 138, which extends vertically away from the bottom portion for supporting the top platen assembly 122. The bottom ring plate 140 is coupled with the support frame 132 to form an upper wall of the lower portion of the support frame 132.

As depicted in FIG. 4, the bottom ring plate 140 is formed to define at least one bottom ring hole 142 therein. Illustratively, the bottom ring plate 140 includes a plurality of bottom ring holes 142. In other embodiments, a single bottom ring hole 142 may be used such as, for example, to make a rice cake. The bottom ring holes 142 receive bottom punches 218 included in the bottom punch assembly 200 to guide movement of the bottom punches 218 as the bottom actuator 134 moves the bottom punch assembly 200 relative to the support frame 132 included in the compression head frame 130. The bottom ring plate 140 is fixed with the support frame 132. In other embodiments, the bottom ring plate 140 is movable vertically relative to the support frame 132 and the moving frame 150.

The compression head frame 130 further includes features for reinforcing the structure and distributing force loads during compression. For example, the compression head frame 130 includes an upper support plate 183, a mount plate 141, a brace assembly 190, at least one tension rod assembly 136 in the illustrative embodiment. The brace assembly 190 and tension rod assembly 136 provide support and rigidity to the compression head frame 130 and compression head assembly 114 during operation, for example, during the compression cycle of the top and bottom punch assemblies 200, 201. The brace assembly 190 provides rigidity to the vertical support 138. The mount plate 141 is disposed below the bottom ring plate 140, extending substantially perpendicular to sidewalls of the lower portion of the support frame 132 and the bottom actuator 134 is coupled to the mount plate 141.

The brace assembly 190 includes a front brace 195, a rear brace 197, and two side braces 199. As shown in FIG. 1, the upper support plate 183 extends aft from the vertical support 138. The front brace 195 is disposed near a front edge of the upper support plate 183 and extends substantially parallel to the front edge. The rear brace 197 is disposed near and extends along rear edge of the upper support plate 183, opposite the front edge. The two side braces 199 are extended between the front brace 195 and the rear brace 197. The two side braces 199 are spaced apart and extend substantially parallel to each other, perpendicular to the front brace 195 and the rear brace 197. The side braces 199 are coupled to the front 195 and rear brace 197 with fasteners.

In the illustrative embodiment, a tension rod assembly 136 is disposed on both sides of the compression head frame 130. Each tension rod assembly 136 extends between and interconnects the lower portion of the support frame 132 with the upper portion of the support frame 132. Illustratively, each tension rod extends from and interconnects the lower portion of the support frame 132 with the upper support plate 183 or vertical support 138. As a result, torsion forces applied to the vertical support 138 from the top platen assembly 122 are transferred through the vertical support 138, upper support plate 183, tension rod 136, and into the lower portion of the support frame 132 to counter the torsion forces and reduce or eliminate deformation and bending of the compression head frame 130.

The tension rod assemblies 136 each include a base 131 and a tension rod 133. The base 131 is coupled to a bottom, side portion of the support frame 132 of the compression head frame 130. In the illustrative embodiment, the base 131 is disposed closer to a rear surface of the base portion of the compression head frame 130. The base 131 includes an upper plate 137. The tension rod 133 includes a fastener 139 on both ends that is capable of fastening the tension rod 133. In the illustrative embodiment, a top fastener 139a couples the tension rod 133 to the upper support plate 183 and a bottom fastener 139b couples the tension rod 133 to the upper plate 137 of the base 131. In the illustrative embodiments, the top fastener 139a couples the tension rod 133 to a rear portion near the rear edge of the upper support plate 183 such that the top fastener 139a of the tension rod 133 is disposed aft of the bottom faster 139b coupled to the base 131. As shown in FIG. 1, the tension rods 133 extend upwards and aft from a respective base 131 to the rear portion of the upper support plate 183. In the illustrative embodiment, the fasteners 139 each comprise a clevis fork and pin and the tension rod 133 comprises a turnbuckle. In some embodiments, the fasteners 139 may comprise any type of joint and/or component capable of coupling the tension rod 133 to the upper support plate 183 and the upper plate 137 of the base 131. In some embodiments, the top fastener 139a may comprise a different type of fastener than the bottom fastener 139b.

The brace assembly 190 and tension rod assemblies 136 act as deflection mitigation features, and work to prevent and/or block deflection of the compression head frame 130 during operation of the compression head assembly 114. The tension rods 133 may be pre-tensioned to apply a force to the vertical support 138 and counter compressive forces felt by the compression head frame during operation of the compression head assembly. The tension rods 133 may be positioned and tensioned to minimize bending of the vertical support 138 during operation of the compression head assembly 114. The braces 195, 197, 199 may increase the rigidity of the upper support plate 183, increasing stiffness of the vertical support 138 and compression head frame 130 to further minimize twisting or bending. In some embodiments, the tension rod 133 are pre-tensioned to deflect and/or bias a top portion of the compression head frame 130 downwards to resist a force in the opposite direction during operation.

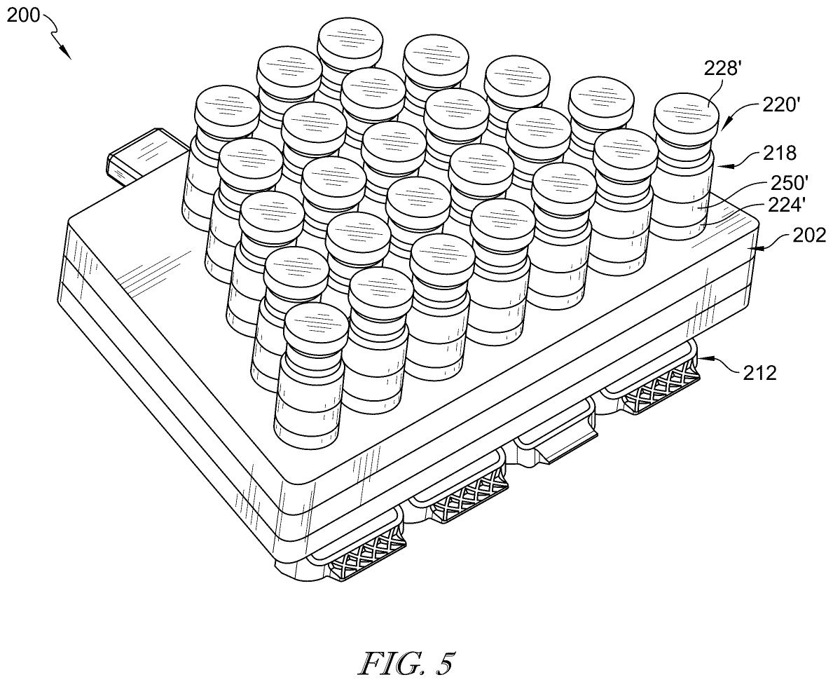

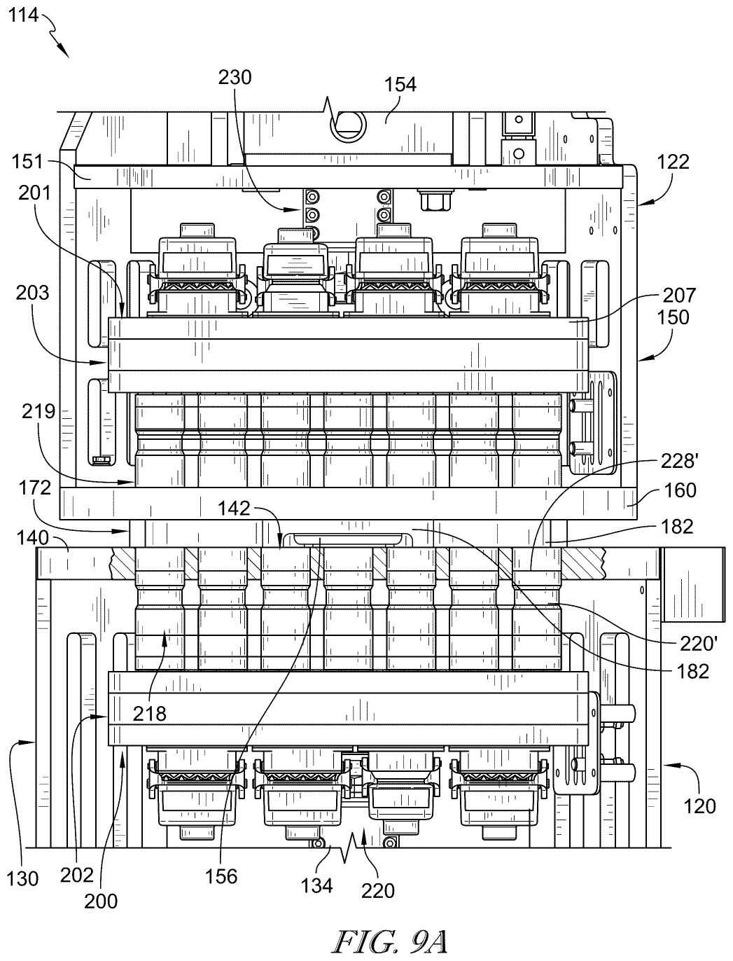

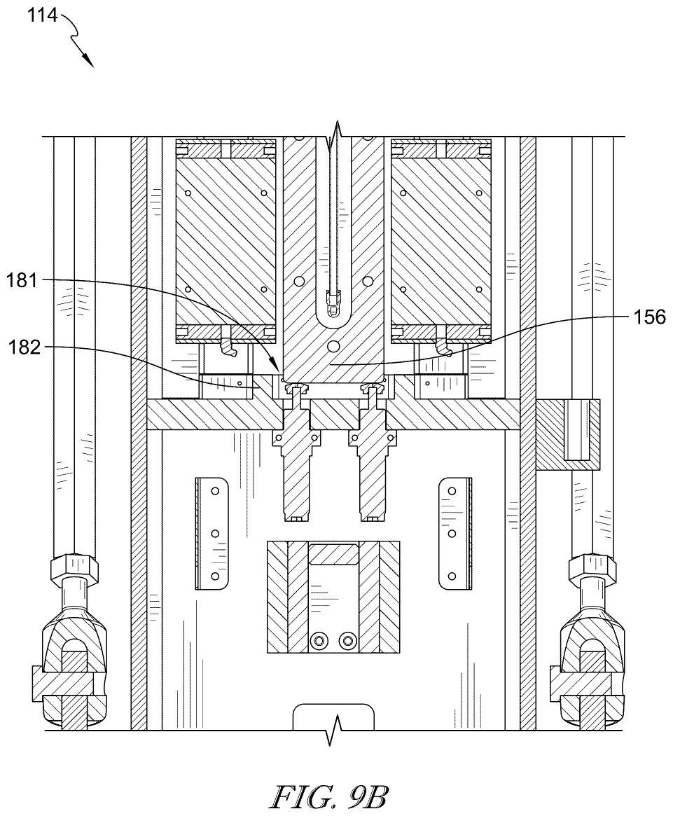

As depicted in FIG. 5, the bottom punch assembly 200 includes a connection manifold 202 and a plurality of bottom punches 218 that extend away from the connection manifold 202. The connection manifold 202 is coupled with the bottom actuator 134 and configured to be moved selectively by the bottom actuator 134 relative to the compression head frame 130 to move the plurality of bottom punches 218 in the corresponding plurality of bottom ring holes 142 as suggested in FIGS. 9A, and 10-11. In the illustrative embodiment, the bottom actuator 134 translates the connection manifold 202 in a vertical direction. The plurality of bottom punches 218 are illustratively slidingly coupled with the connection manifold 202. The plurality of bottom punches 218 are able to slide and/or relative to the connection manifold 202 in the X-direction and Y-direction (horizontal plane). In other embodiments, the plurality of bottom punches 218 are integrally formed with the connection manifold 202 as a single, one-piece component. In some embodiments, the bottom punch assembly 200 includes a single bottom punch 218 that extends into a single bottom ring hole 142.

In the illustrative embodiment, each of the plurality of bottom punches 218 is individually heated and temperature controlled. In other embodiments, all or groups of the plurality of bottom punches 218 are heated via heating of the connection manifold 202. In other embodiments, the plurality of bottom punches 218 may be grouped into zones and monitored by zone rather than individually. In the illustrative embodiment, the bottom punch assembly 200 further includes electrical connectors 212 for connecting heating elements and sensors with a controller. In some embodiments, groups of bottom punches 218 are heated based on a single temperature sensor located in one of the punches 218 or in the connection manifold 202.

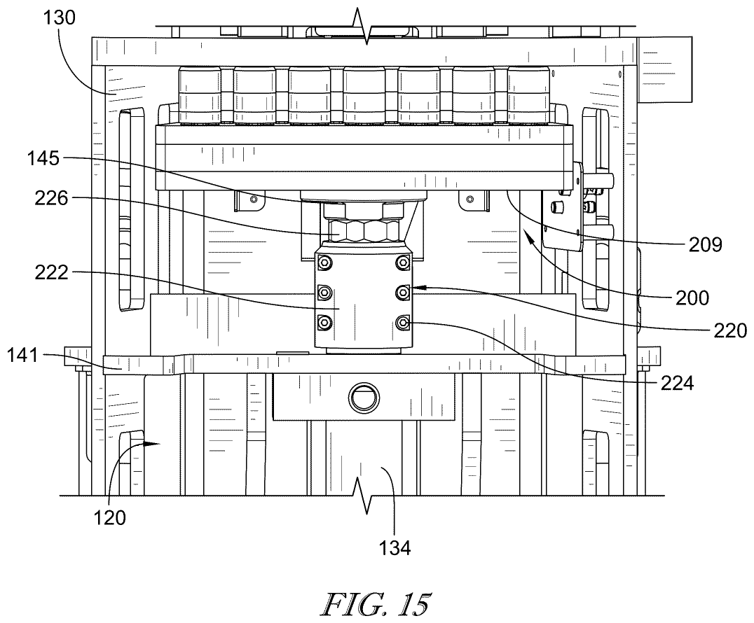

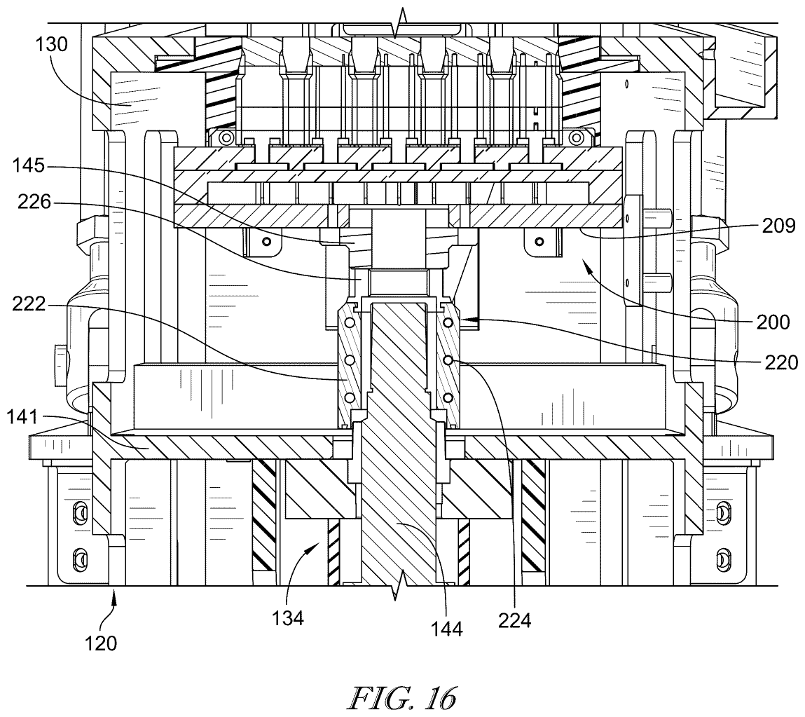

As depicted in FIGS. 15 and 16, the bottom collar assembly 220 is disposed along the shaft of piston 144 of the bottom actuator 134 between the bottom punch assembly 200 and the mount plate 141 of the compression head frame 130, forming a mechanical stop or hard stop for the actuator 134. A position of the bottom collar assembly 220 on the piston 144 sets a maximum distance the actuator 134 can retract the bottom punch assembly 200 from the bottom ring plate 140 to prevent the bottom punch assembly 200 from being completely retracted from the ring plate 140. In other words, the bottom collar assembly 220 may be used to block punches 218 of the bottom punch assembly 200 from moving too far downwardly and escaping the bottom ring holes 142 of the bottom ring plate 140. Because, if the bottom punches 218 were to escape the bottom ring holes 142, the bottom punches 218 may become misaligned with the bottom ring holes 142 and cause the compression head assembly 114 to seize when the bottom actuator 134 tries to move the bottom punch assembly 200 upwardly.

The collar assembly 220 is placed between the mount plate 141 and the punch assembly 200 at a position where the collar assembly 220 physically stops the actuator 134 from retracting a top surface 228′ of the punch assembly 200 past a lower surface of the bottom ring plate 140. The bottom collar assembly 220 includes a collar 222, at least one collar fastener 224, and an adjustment nut 226. The collar 220 and adjustment nut 226 at least partially extend around a diameter of the piston 144. In the illustrative embodiment, the collar 222 includes two halves that are held together around the piston 144 by multiple fasteners 224. In other embodiments, the collar 222 may be a single piece or have more than two pieces. In other embodiments, the bottom collar assembly 220 may not have fasteners 224. The adjustment nut 226 is disposed between the collar 222 and lower surface 209 of the punch assembly 200. The adjustment nut 226 extends around the piston 144 and is adjustably coupled to the piston 144, for example via threads, such that a position of the nut 226 on the piston 144 can be changed. The position of the adjustment nut 226 allows for micro adjustments of the mechanical stop created by the collar assembly 220. By adjusting a position of the adjustment nut 226 along the piston 144 with respect to the connection flange 145 of the punch assembly 200, the maximum retraction distance can be changed.

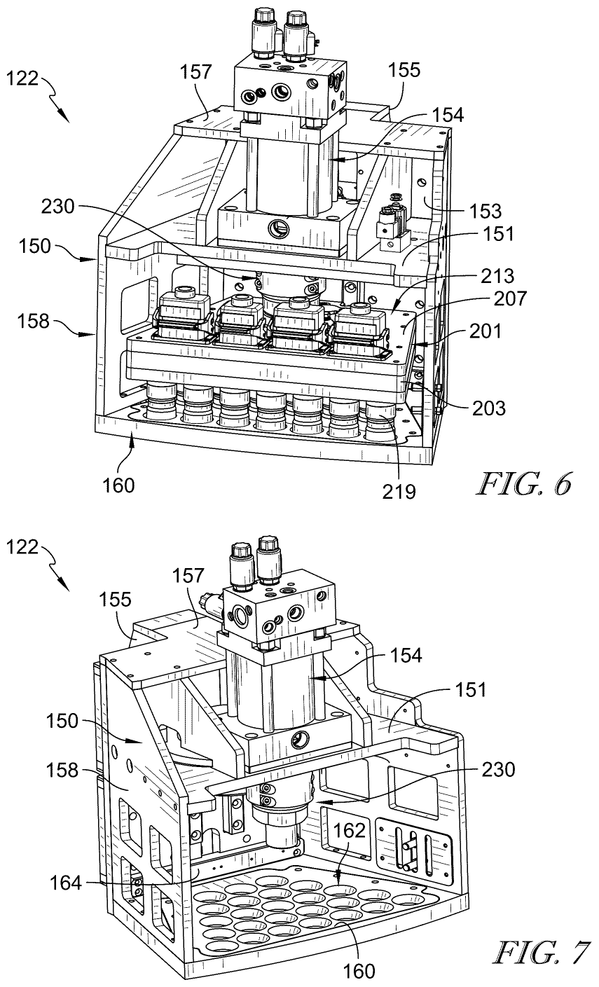

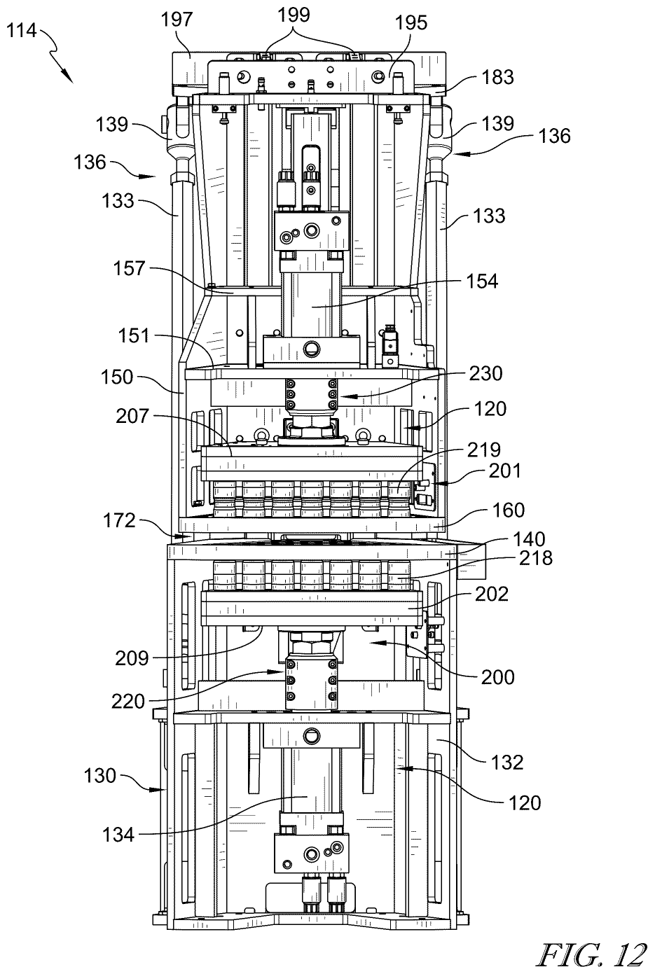

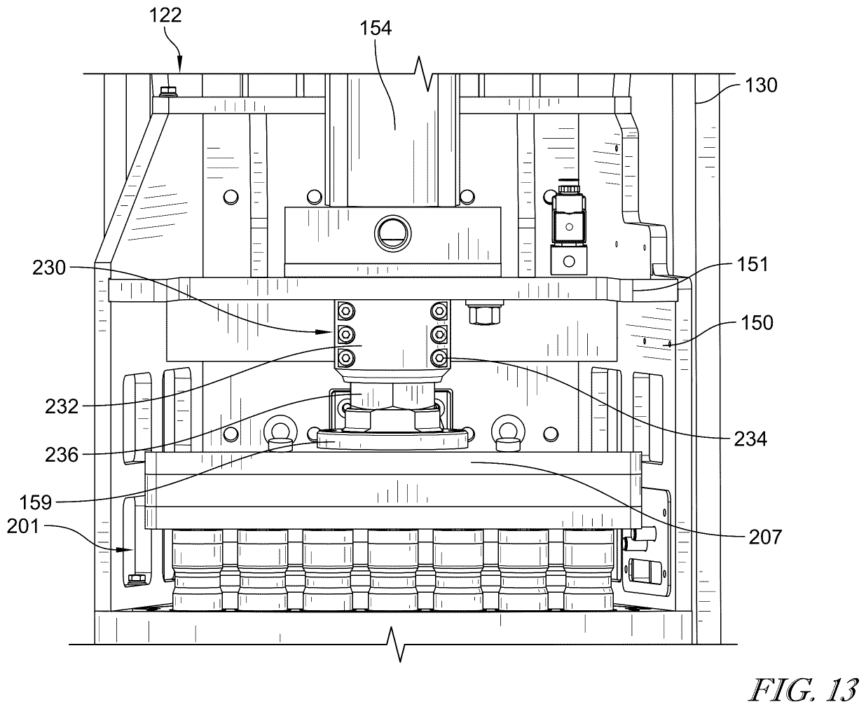

As depicted in FIGS. 6-7, the top platen assembly 122 includes a moving frame 150, a top punch assembly 201, a top actuator 154, and a top collar assembly 230. The moving frame 150 provides a rigid support structure that is movably coupled with the compression head frame 130. The top punch assembly 201 is configured to move relative to the moving frame 150 and confront the bottom punch assembly 200 included in the bottom platen assembly 120 to compress, cook, and allow expansion of the raw ingredients 12 there between. The top actuator 154 is coupled with the moving frame 150 and the top punch assembly 201 and configured to move selectively between an extended position and a retracted position to move the top punch assembly 201 relative to the moving frame 150. In the illustrative embodiment, the top actuator 154 includes a piston 152 that is coupled to the top punch assembly 201 via a cylindrical connection flange 159 that is fixedly attached to an upper surface 207 of the punch assembly 201, as shown in FIGS. 12-13.

The moving frame 150 includes a top platen carriage 158 and a top ring plate 160 coupled with the top platen carriage 158 as depicted in FIG. 7. The top platen carriage 158 is coupled with the compression head frame 130 for movement with the compression head frame 130 along the carriage path 16. The top ring plate 160 is coupled with the top platen carriage 158 to form a lower wall of the top platen carriage 158. The top ring plate 160 is formed to define a plurality of top ring holes 162 therein. The top ring holes 162 receive top punches 219 included in the top punch assembly 201 to guide movement of the top punches 219 as the top actuator 154 moves the top punch assembly 201 relative to the top platen carriage 158. In other embodiments, the top ring plate 160 is omitted and the top punches 219 are guided by the top actuator 154 and the bottom ring plate 140. In some embodiments, the top ring plate 160 includes a single top ring hole 162 and the top punch assembly 201 includes a single top punch 219.

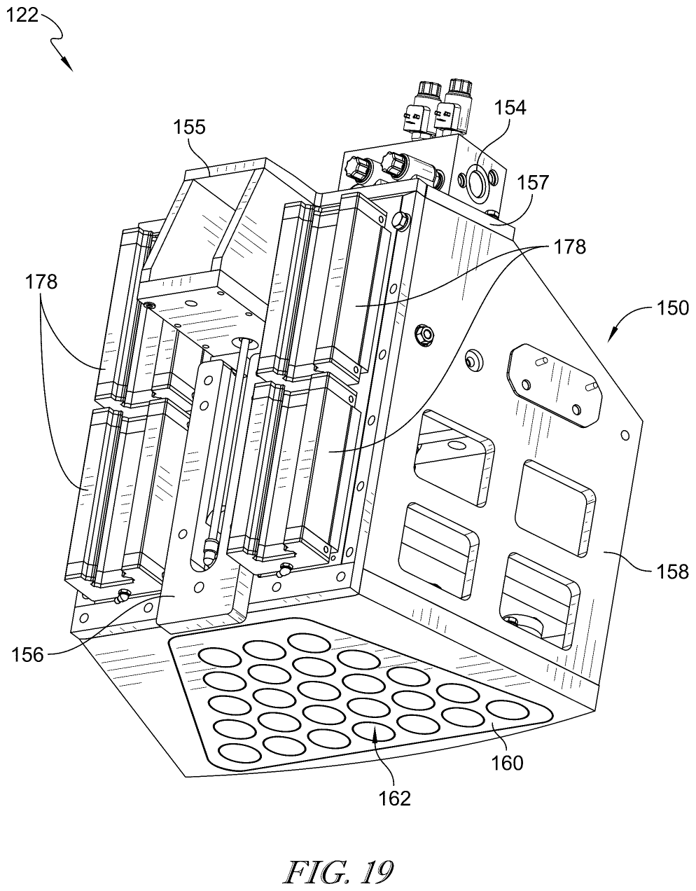

The top platen carriage 158 illustratively includes a platen cage 153, a brace 155, a tab 156, an intermediate plate 151, and an upper plate 157 as depicted in FIGS. 6-7 and 19. The platen cage 153 houses the top punch assembly 201. The brace 155 extends from a back side of the platen cage 153 for attachment with a moving frame actuator 180. The upper plate 157 is coupled with an upper end of the platen cage 153 to react against the locking assembly 126. The intermediate plate 151 is disposed below the upper plate 157 and above the top ring plate 160, and extends perpendicular to side walls of the platen cage 153.

In the illustrative embodiment, the tab 156 extends along a back side of the platen cage 153 and corresponds to an opening 181 formed in the lower platen assembly. The interlocked tab 156 and opening 181 block rotation of the moving frame 150 relative to the compression head frame 130 during operation of the compression head assembly 114. During the compression cycle, the compressive force applied by the top punch assembly 201 and the bottom punch assembly 200 may create a torsion force that urges the top platen assembly 122 to rotate relative to the bottom platen assembly 120. For example, the top platen assembly 122 may be urged to rotate counter-clockwise in FIG. 24. The interlocking of the tab 156 and opening 181 resists and/or blocks this motion. The tab 156 extends past a lower surface of the platen cage 153 and the top ring plate 160 such that the tab 156 protrudes past top ring plate 160. In the illustrative embodiment, the tab 156 is an elongated shape with a substantially rectangular cross section, a longer side of the rectangular cross section disposed parallel to a back side of the platen cage 153. In other embodiments, the tab 156 may be any suitable shape and/or disposed in any suitable location on the top platen carriage 158 to interlock with the lower platen assembly.

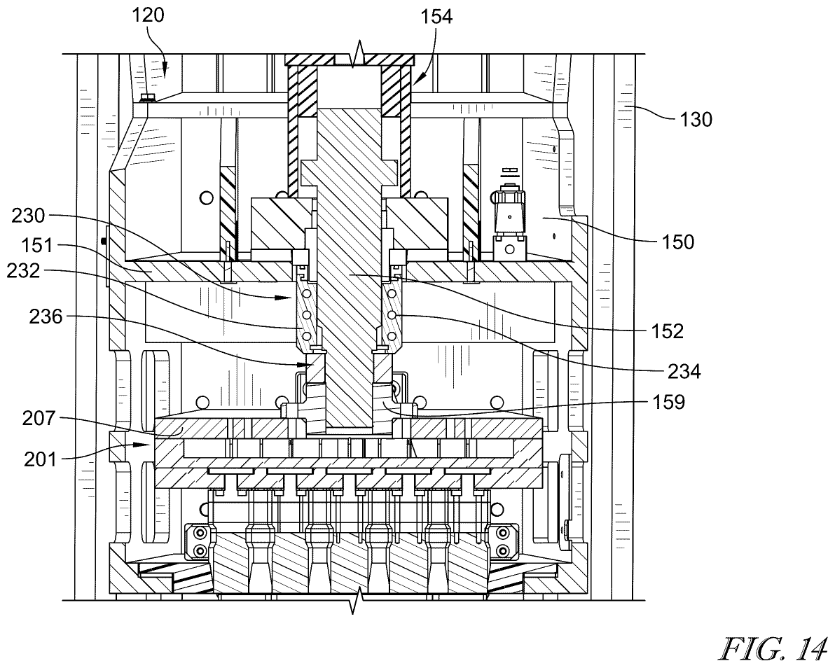

As depicted in FIGS. 13 and 14, the top collar assembly 230 is disposed along the shaft of piston 152 of the top actuator 154 between the top punch assembly 201 and the intermediate plate 151 of the top platen carriage 158, forming a mechanical stop for the actuator 154. A position of the top collar assembly 230 on the piston 152 set a maximum distance the actuator 154 can retract the top punch assembly 201. In the illustrative embodiment, at certain points during operation of the compression head assembly 114, it can be advantageous to retract the punch assembly 201 to be flush with the top ring plate 160. The collar assembly 230 is placed between the intermediate plate 151 and the punch assembly 201 at a position where, once the punch assembly 201 is flush with the ring plate 160, the collar assembly 230 physically stops the actuator 154 from retracting the punch assembly 201 any further.

The top collar assembly 230 includes a collar 232, at least one collar fastener 234, and an adjustment nut 236. The collar 232 and adjustment nut 236 at least partially extend around a diameter of the piston 152. In the illustrative embodiment, the collar 232 includes two halves that are held together around the piston 152 by multiple fasteners 234. In other embodiments, the collar 232 may be a single piece or have more than two halve pieces. In other embodiments, the top collar assembly 230 may not have fasteners 234. The adjustment nut 236 is disposed between the collar 232 and upper surface 207 of the punch assembly 201. The adjustment nut 236 extends around the piston 152 and is adjustably coupled to the piston 152, via threads for example, such that a position of the nut 236 on the piston 152 can be changed. The position of the adjustment nut 236 allows for adjustments of the mechanical stop created by the collar assembly 230. By adjusting a position of the adjustment nut 236 along the piston 152 with respect to the connection flange 159 of the punch assembly 201, the maximum retraction distance can be changed.

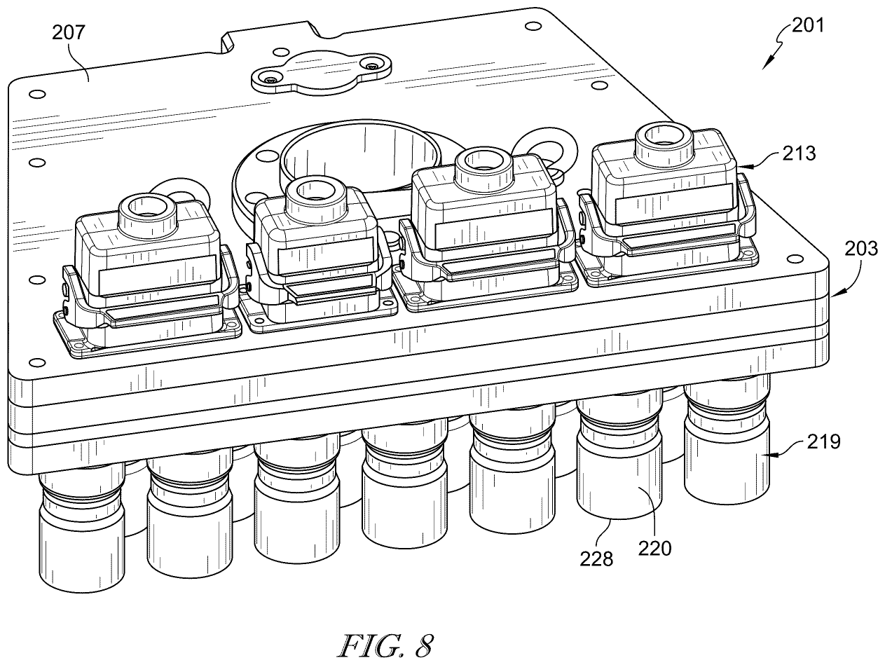

As depicted in FIG. 8, the top punch assembly 201 includes a connection manifold 203 and a plurality of top punches 219 that extend away from the connection manifold 203. The connection manifold 203 is coupled with the top actuator 154 and configured to be moved selectively by the top actuator 154 relative to the moving frame 150 to move the plurality of top punches 219 in the corresponding plurality of top ring holes 162 as well as the plurality of bottom ring holes 142 as suggested in FIGS. 9A and 10-11. In the illustrative embodiment, the top actuator 154 translates the connection manifold 203 in a vertical direction. The plurality of top punches 219 are illustratively slidingly coupled with the connection manifold 203. The plurality of top punches 219 are able to slide and/or relative to the connection manifold 203 in the X-direction and Y-direction (horizontal plane). In other embodiments, the plurality of top punches 219 are integrally formed with the connection manifold 203 as a single, one-piece component. For example, the top punches 219 may be bolted to the manifold 203.

In the illustrative embodiment, each of the plurality of top punches 219 is individually heated and temperature controlled. In other embodiments, all or groups of the plurality of top punches 219 are heated via heating of the connection manifold 203. In other embodiments, the plurality of top punches 219 may be grouped into zones and monitored by zone rather than individually. In the illustrative embodiment, the top punch assembly 201 further includes electrical connectors 213 for connecting heating elements and sensors with the controller. As depicted in FIG. 7, the moving frame 150 may include an optional top air knife 164 coupled with the top platen carriage 158 to blow any uncooked raw ingredients 12, food product 14, or other debris away from the top punch assembly 201.

The bottom actuator 134 and the top actuator 154 are configured to move the bottom punch assembly 200 and the top punch assembly 201, respectively, between retracted and extended positions to allow the raw ingredients 12 to be fed into the compression head assembly 114 and compressed, cooked, and allowed to expand. In the illustrative embodiment, the bottom actuator 134 and the top actuator 154 are controlled to move to and between predetermined positions. In some embodiments, the predetermined positions may be adjusted manually or via software. In some embodiments, the bottom actuator 134, top actuator 154, and other actuators in the system are controlled to move for predetermined amounts of time.

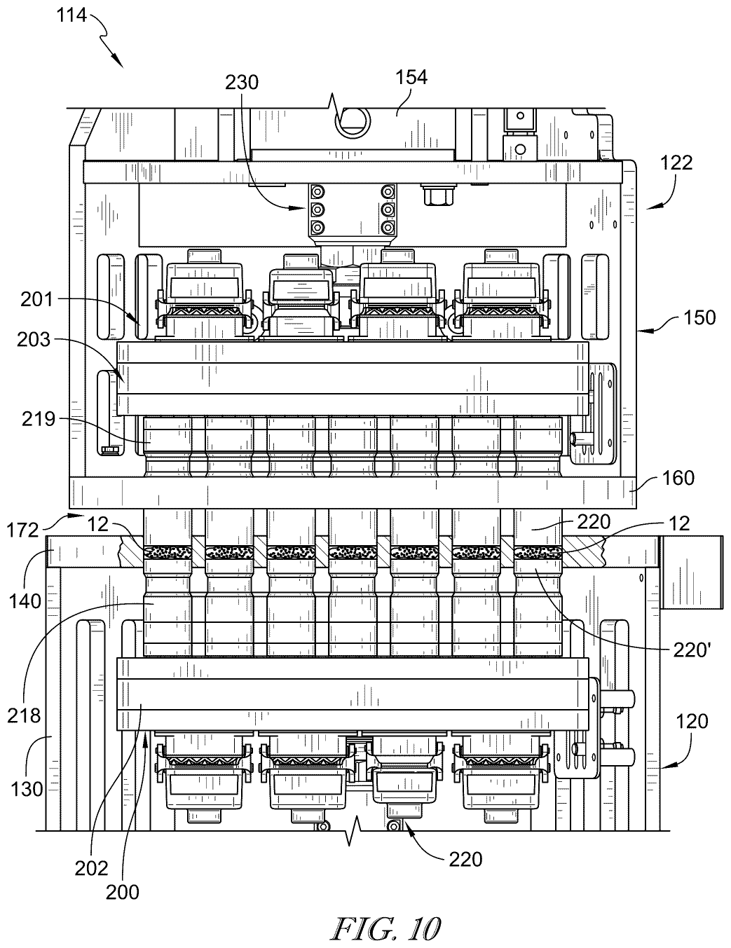

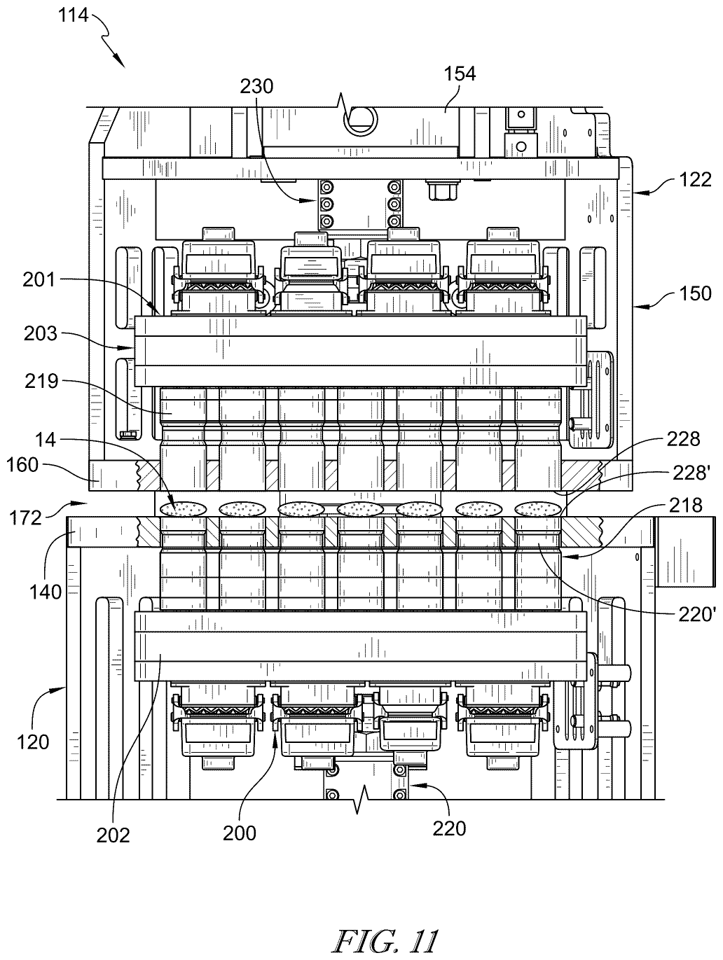

As suggested in FIG. 9A, during operation of the compression head assembly 114, the bottom actuator 134 is retracted to cause food contacting surfaces 228′ of the bottom punches 218 to be located in the respective bottom ring holes 142 to form a cavity for receiving the raw ingredients 12 when being dosed with the raw ingredients 12. The top actuator 154 is retracted to cause food contacting surfaces 228 of the top punches 219 to be spaced apart from the bottom ring plate 140 as shown in FIG. 9A to not obstruct a space 172 between the moving frame 150 and the compression head frame 130. The feed system 400 delivers the raw ingredients 12 into the cavity of each bottom ring hole 142 as discussed with reference to FIG. 10.

As depicted in FIG. 10, during cooking of the raw ingredients 12, the bottom actuator 134 extends to move the plurality of bottom punches 218 upward, but keeping the food contact surfaces 228′ within the respective bottom ring holes 142. In other embodiments, the bottom actuator 134 maintains its position or slightly retracts. The top actuator 154 extends to move the plurality of top punches 219 downward such that the food contact surfaces 228 of the top punches are located within the bottom ring holes 142 and cooperate with the bottom punches to compress and cook the raw ingredients 12.

As a result of the pressure and heat, the starch in the raw ingredients 12 is gelatinized, becomes amorphous, and moisture including chemically bound water of the raw ingredients 12 is driven off to build up a high internal vapor pressure. The built-up vapor pressure is then suddenly released by quickly retracting the bottom actuator 134 and/or the top actuator 154 relative to one another. As a result, the compressed raw ingredients 12 explosively expands to form the expanded food product 14, such as, for example, a puffed or popped wafer, filling the expansion chamber space defined in the bottom ring holes 142 between the top punch 219, the bottom punch 218, and the bottom ring plate 140. In some embodiments, the top actuator 154 and/or the bottom actuator 134 are partially or fully retracted, extended, and retracted in any suitable pattern during the cooking step 40 to control cooking temperature, shape, thickness, surface flatness, etc. of the food product 14. Optionally, the moving frame actuator 124 can be used to move the moving frame 150 selectively and thereby control and adjust a size of the expansion chamber space.

After the food product 14 is produced, the bottom actuator 134 extends to cause the food contact surface 228′ of the bottom punches 218 to be generally aligned and flush with an upper surface of the bottom ring plate 140 as depicted in FIG. 11 to assist in the removal and/or cleaning of the bottom platen assembly 120 during removal of the product and/or cleaning of the compression head assembly 114. The top actuator 154 retracts to move top punches 219 away from the bottom punches 218. In the illustrative embodiment, the top actuator 154 moves the top punches 219 so that the food contacting surfaces 228 are generally aligned and flush with a lower surface of the top ring plate 160 as depicted in FIG. 11.

In conventional compression head assemblies, the maximum gap (similar to gap 172) between the top punches and the bottom punches is fixed and relatively small. The gap may be designed to be as small as possible and only as big as needed to allow a feeding tray to pass between the top punches and the bottom punches to deliver raw ingredients to the compression head before retracting and allowing the top and bottom punches to compress the raw ingredients. Because the size of such gap is relatively small and fixed in conventional assemblies, cleaning of the punch assemblies may be difficult. Typically, an operator shuts off the compression head assembly and uses one or more tools (picks, scrappers, etc.) to clean the assembly and scrape each of the punches, the bottom ring plate, or other surfaces of the assembly. To clean the top punches, a pick or other tool is inserted in the gap and the relatively small dimensions may limit the efficiency of the cleaning. Moreover, conventional assemblies do not include a top ring plate such that raw ingredients, food product, and other debris may more easily find its way onto the sidewalls of the top punches (where it may become overcooked and burned) and other areas within the assembly.

In illustrative embodiments, the present disclosure provides a compression head assembly 114 that includes the optional top ring plate 160 which receives the top punches 219 within the top ring holes 162 formed therein to prevent and limit ingress of the raw ingredients 12, food product 14, and other debris from moving onto the sidewalls of the top punches 219 or bottom surfaces of the connection manifold 203. Food build up and debris on the sidewalls of punches and other surfaces in conventional assemblies can cause issues such as falling into the food product and contaminating the food product, obstructing movement of the punches/components causing undesired cooking pressures, times, temperatures, sizes, etc. As a result of one or more features of the present disclosure, cleaning of the top punches 219 is minimized and any minimal debris may be ejected by the pressurized fluid of the top air knife 164.

The compression head assembly 114 of the present disclosure includes the moving frame 150 (compared to embodiments with a fixed frame 150). Such embodiments having the moving frame 150 further include a moving frame actuator unit 124 and locking assembly 126 which cooperate to move selectively the top platen assembly 122 away from the bottom platen assembly 120 to increase a size of the gap 172 and allow greater access for the cleaning step 60 and/or repair and maintenance. In other embodiments, the bottom platen assembly 120 moves away from the top platen assembly 122 or both assemblies 120, 122 move. Such movement and opening of the gap 172 is contrasted against conventional compression head assemblies in which the gap between platens is small and fixed as discussed above along with the difficulties that come with such small fixed sized gap.

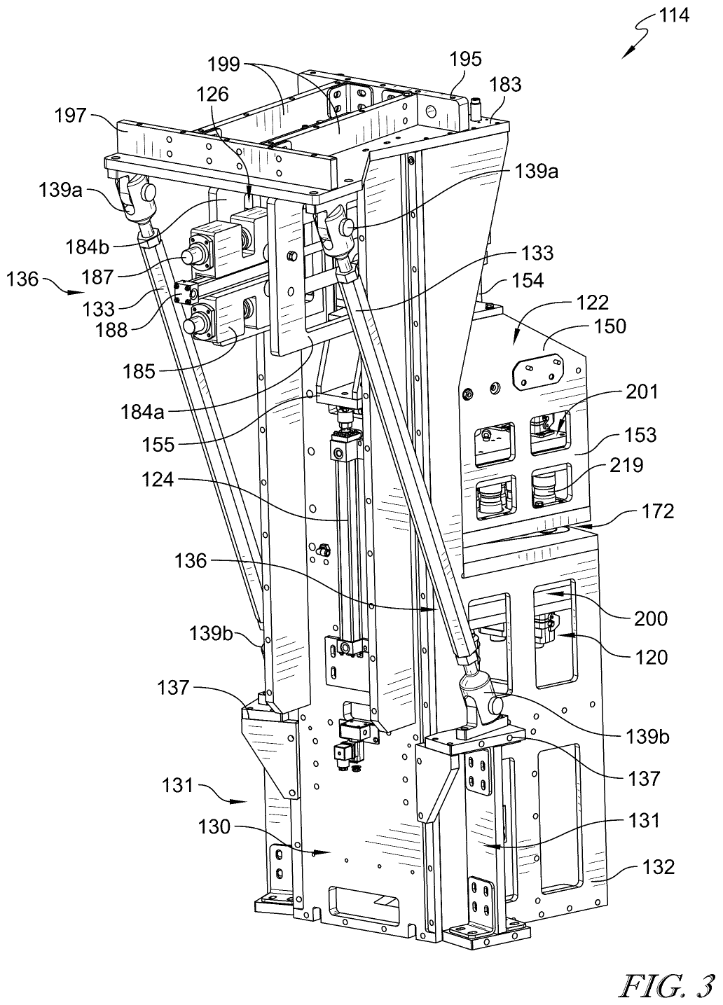

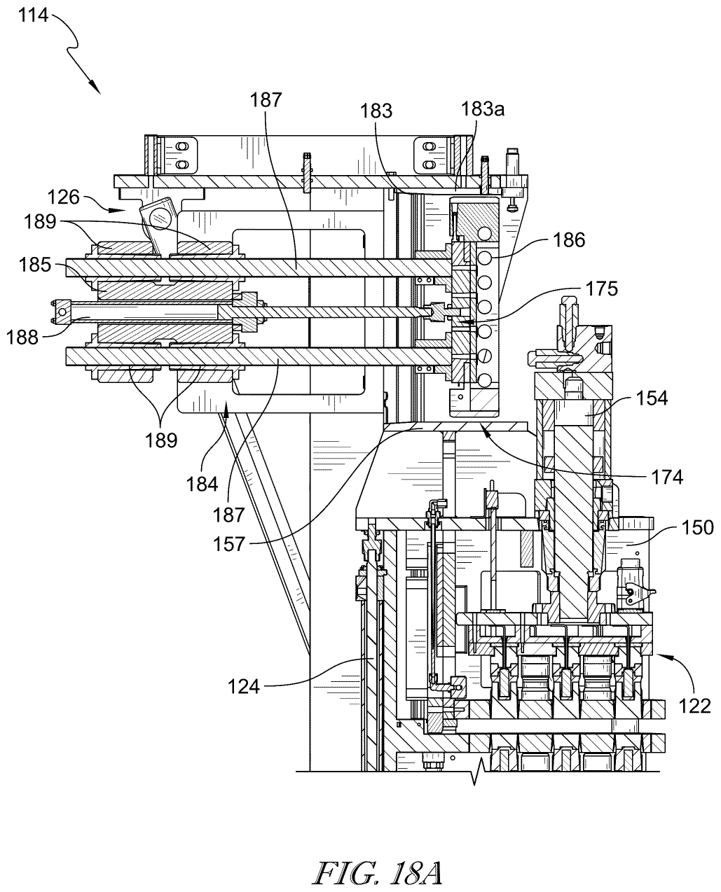

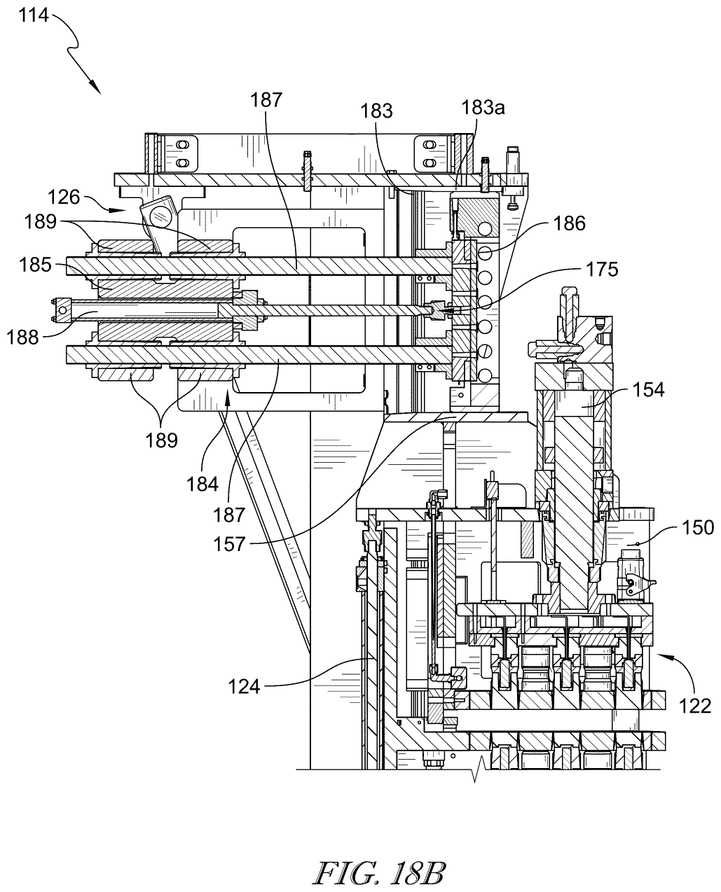

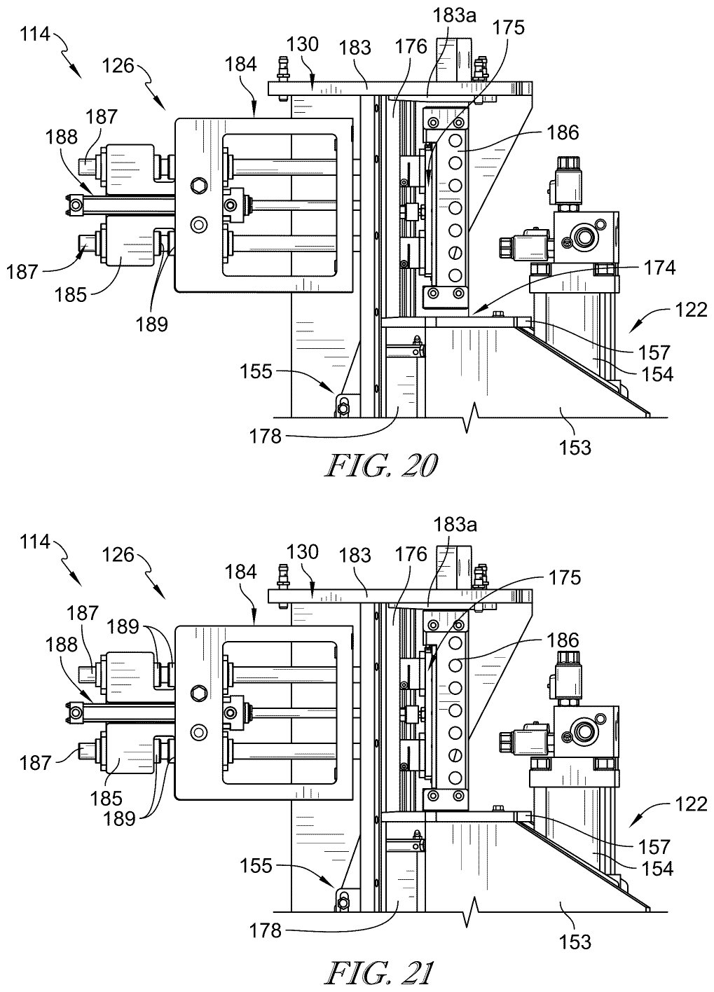

The moving frame actuator unit 124 includes frame rails 176, platen guides 178, and a moving frame actuator 180 as shown in FIGS. 2-4, and 17A-23. The frame rails 176 are coupled with the compression head frame 130 as shown in FIG. 4 and provide a guided path for movement of the top platen assembly 122 relative to the bottom platen assembly 120. The platen guides 178 are coupled with the top platen assembly 122 and mate with the frame rails 176 to slide along the frame rails 176 when the top platen assembly 122 is moved. The moving frame actuator 180 is coupled with the compression head frame 130 and the top platen assembly 122 to move selectively the moving frame 150 of the top platen assembly 122 relative to the compression head frame 130.

The frame rails 176 include a first frame rail 177 and a second frame rail 179 spaced apart from the first frame rail 177 as shown in FIG. 4. Illustratively, the frame rails 176 extend from a platen stop 182 of the compression head frame 130 to the upper support plate 183 of the compression head assembly 114. The platen stop 182 provides a surface that is vertically spaced apart from the bottom ring plate 140 and is configured to engage a lower surface of the moving frame 150 of the top platen assembly 122 to physically limit downward movement of the moving frame 150 beyond the platen stop 182 and thereby help provide the gap 172. Each of the first frame rail 177 and the second frame rail 179 are formed to include slots that run vertically on each side and receive mating features of the platen guides 178. The structure of the compression head assemblies 114, including the dual frame rails 177, 179 as well as other reinforcements and structures such as the cover plate 183, contribute to the stiffness of the assemblies 114. The rigidity and stiffness of the assemblies 114 help to keep the plates 140, 160 parallel during the compression cycle and resist non-axial forces.

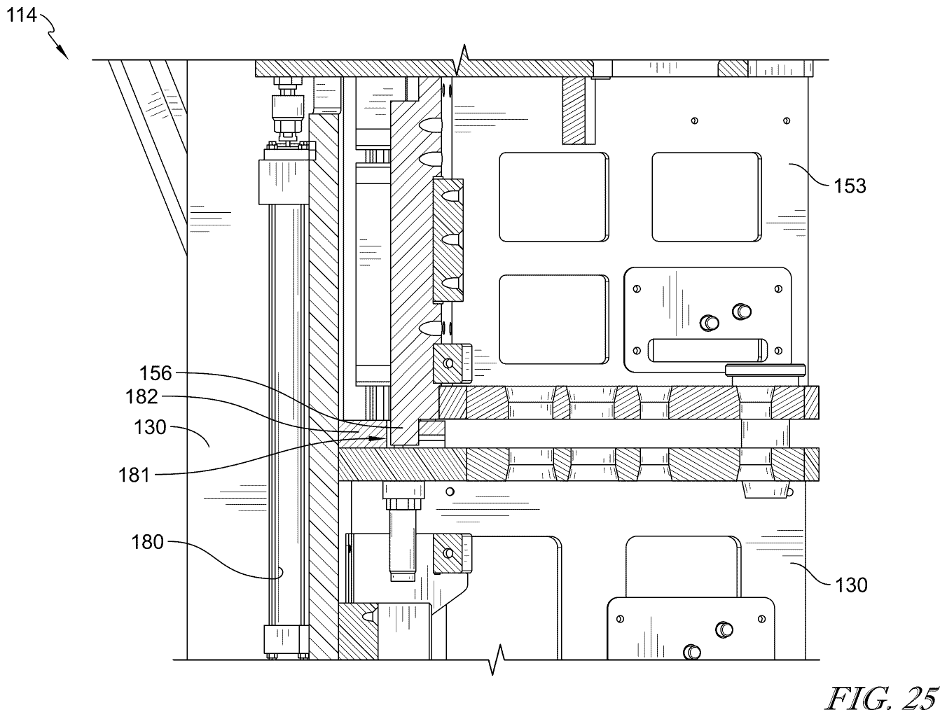

The platen stop 182 is formed to include an opening 181 configured to receive a tab 156 extending from the top platen carriage 158. As depicted in FIGS. 4, 9B, and 24-25, the platen stop 182 may be a block extending away from an upper surface of the bottom ring plate 140 that is shaped to form the opening 181. In the illustrative embodiment, the opening 181 is an elongated slot extending parallel to a back side of the compression head frame 130. The opening 181 is positioned and/or shaped to correspond to the tab 156 of the top platen carriage 158. The opening 181 and the tab 156 are shaped to interlock when the top platen assembly is in the lowered position. In the illustrative embodiment, the tab 156 interlocks with the opening 181 by being inserted and/or extending through the opening 181 when the top platen assembly is lowered.

The illustrative embodiment depicts the tab 156 and opening 181, the brace assembly 190 on the upper support plate 183, and the tension rod assemblies 136, which may all work to block twisting, bending, deflecting, and/or any other deformation of the compression head frame 130. These features may also work to keep the top ring plate 160 and punch assembly 201 substantially parallel with the bottom ring plate 140 and punch assembly 200. For example, in some embodiments, the tension rod assemblies 136 pre-tension the compression head frame 130 to push and/or pull the top of the compression head frame 130 such that the top ring plate 160 and the bottom ring plate 140 are not parallel with each other when the compression head assembly 114 is not undergoing compression. The tension rod assemblies 136 may provide a constant counter force to the force experienced by the compression head assembly 114 during the compression cycle, such that when the compression head assembly 114 is not in operation, or is not compressing the raw ingredients 12 during the cook cycle, the counter force provided by the tension rod assemblies 136 forces the ring plates 140, 160 out of parallel with each other. The compressive force provided by the actuators 134, 154 during the cook cycle acts against the pre-tension force provided by the tension rod assemblies 136 and forces the ring plates 140, 160 into a parallel position with each other. In other embodiments, the compression head assembly 114 may optionally include all, some, or none of these features. In other embodiments, alternative or additional features may be implemented to provide similar reinforcement to the compression head assembly 114.

The platen guides 178 are coupled to a back side of the moving frame 150 as shown in FIG. 23. The moving frame actuator 180 is coupled with a back side of the compression head frame 130. The moving end of an actuator rod included in the moving frame actuator 180 is coupled to the moving frame 150. In the illustrative embodiment, the top platen carriage 158 of the moving frame 150 includes the platen cage 153 and the brace 155 that extends away from the platen cage 153. The moving frame actuator 180 is coupled with the brace 155 and applies selectively a force to the brace 155 to raise and lower the top platen assembly 122.

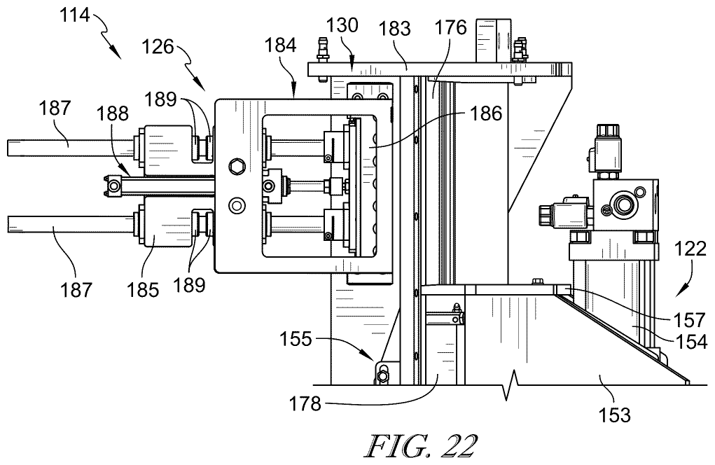

The locking assembly 126 is movable between an extended position, as depicted in FIGS. 1, 17A-18B, and 20-21, and a retracted position, as depicted in FIGS. 22 and 23. In the extended position, the locking assembly 126 extends into the space between the upper plate 157 of the top platen assembly 122 and the upper support plate 183 of the compression head frame 130 to block the top platen assembly from moving (via the moving frame actuator unit 124) relative to the compression head frame 130. In the extended position, the locking assembly 126 maintains the top platen assembly 122 in place during the cooking step 40 and resists the upward force caused by the top actuator 154 pushing the top punches 219 into compression against the raw ingredients 12 and the bottom punches 218. In the retracted position, the locking assembly 126 is retracted from the space between the upper plate 157 of the top platen assembly 122 and the upper support plate 183 of the compression head frame 130. In the retracted position, the locking assembly 126 is spaced apart or otherwise not engaged with the top platen assembly 122 to allow the top platen assembly 122 to be moved by the moving frame actuator unit 124 as suggested in FIGS. 22 and 23. As such, the top platen assembly 122 may be moved away from the bottom platen assembly 120 during the cleaning step 60.

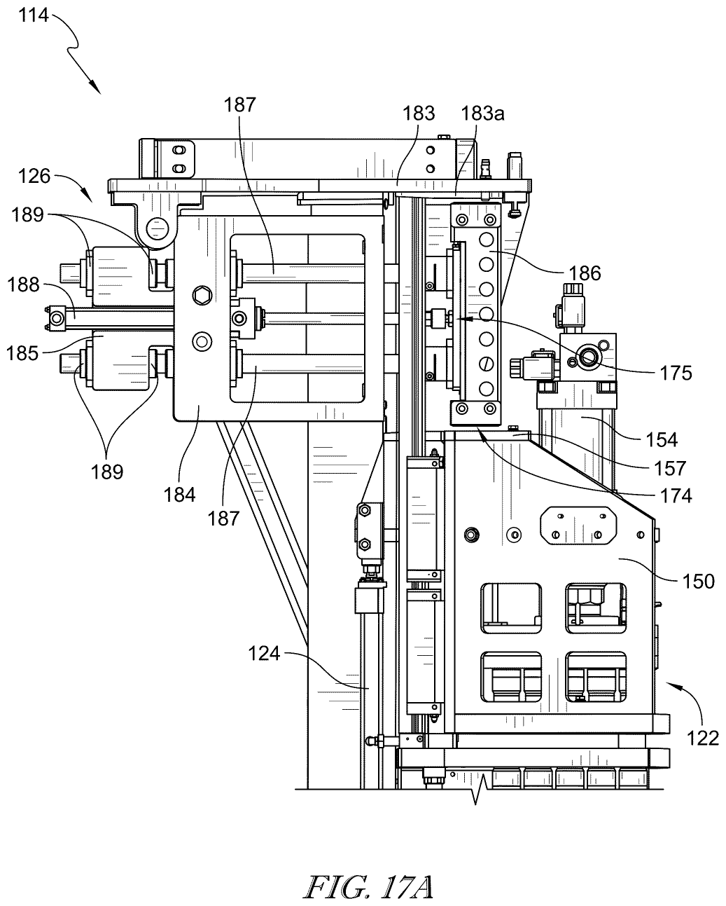

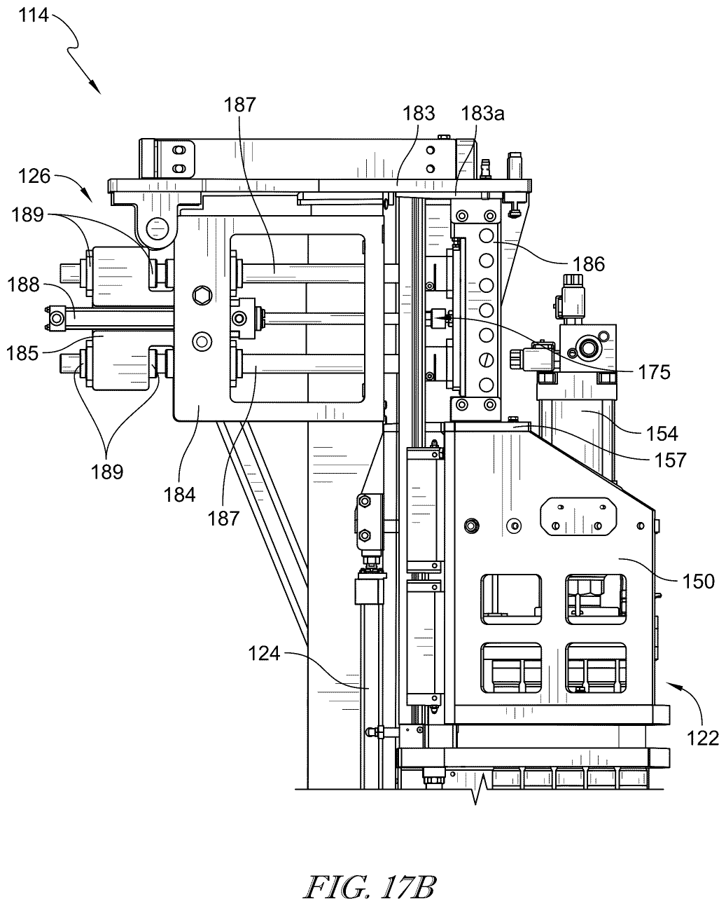

The locking assembly 126 includes a mount 184, a locking block 186, a lock actuator 188, a support block 185, and, optionally, at least one support shaft 187 as depicted in FIGS. 17A-18B and 20-23. In the illustrative embodiment, the mount 184 includes a pair of support plates 184a, 184b. Each plate is coupled with the back side of the compression head frame 130 on either side of the cutout 135, extending aft of the back side of the compression head frame. The plates 184a, 184b extend substantially parallel and spaced apart from each other to provide room for the lock actuator 188, the support block 185, the support shafts 187, and the locking block 186 to extend between the plates 184a, 184b. The locking block 186 is a rigid member configured to physically block movement of the top platen assembly 122.

The illustrative locking block 186 is a cuboid that has a height sized to cause the locking block 186 to engage a tapered stopper 183a coupled to the upper support plate 183 of the compression head frame 130 and the upper plate 157 of the moving frame 150 as depicted in FIGS. 17B, 18B, and 21. In other embodiments, the locking block 186 may be a cylinder or any other suitable shape and may engage other surfaces of the compression head assembly 114 to block selectively movement of the top platen assembly 122. The locking block 186 is slidably coupled to the lock actuator 188 via a slide plate assembly 175 that allows the locking block 186 the slide relative to the lock actuator 188 in a direction perpendicular to the lock actuator 188 and/or in a direction of motion of the moving frame 150. In some embodiments, the slide plate assembly 175 includes a plate fixedly coupled to an end of the lock actuator 188 and the support shafts 187. A back side of the locking block 186 is shaped to form a groove in which the plate fits such that the plate can slide up and down the back side of the locking block 186. In other embodiments, a different slideable coupling may be used.

The lock actuator 188 is coupled with the mount 184 and the locking block 186 via the support block 185 and is configured to move between the extended position and the retracted position. In the illustrative embodiment, the support block 185 is generally H shaped in profile, and is shaped form a cutout along a central portion through which the lock actuator 188 extends. The support block 185 is shaped to form apertures on either side of the central portion through which the support shafts 187 extend. In the illustrative embodiment, a support shaft 187 is disposed above and below the lock actuator 188. One or more bearings 189 may be disposed around the support shaft 187 between the support shaft 187 and the support block 185 to allow for movement of the locking block 186 between the extended and retracted positions.

In the extended position, the locking block 186 may be engage with the compression head frame 130 and the top platen assembly 122 such that the locking assembly 126 is in the locked orientation as depicted in FIG. 21. The structure and operation of the locking block 186 advantageously transmits the force experienced by the locking block 186 during the compression cycle back into the compression head frame 130, where the compression head frame 130 is coupled to the locking assembly 126, rather than transmitting the force into components that guide movement during operation of the punch assemblies 200, 201, such as the frame rails 176. In the retracted position, the locking block 186 is spaced apart from the top platen assembly 122 such that the locking assembly 126 is in the unlocked orientation as depicted in FIGS. 22 and 23. As shown in FIG. 22, in the unlocked orientation, the locking block 186 is moved through the cutout 135 in the compression head frame 130 to a space defined by the mount 184 behind the compression head frame 130.

During operation, the compression head assembly 114 is moveable between a locked orientation, as depicted in FIGS. 1, 17B, 18B and 21, an intermediate orientation, as depicted in FIGS. 17A, 18A, and 20, and an unlocked orientation, as depicted in FIGS. 22, 23, 26 and 27. In the locked orientation, the locking block 186 is extended into the space between the upper plate 157 of the top platen assembly 122 and the upper support plate 183 of the compression head frame 130. In the intermediate orientation, the top platen assembly 122 is positioned below the upper support plate 183 of the compression head frame 130 a distance that is greater than a height of the locking block 186 to allow enough space for the locking block 186 to be extended and retracted from between the top platen assembly 122 and the upper support plate 183. The locking block 186 is in the extended position in the intermediate orientation, and the position of the top platen assembly 122 forms a gap between the bottom of the locking block 186 and the upper plate 157 of the top platen assembly 122, and a gap between the top of the locking block 186 and the upper support plate 183 of the compression head frame 130.

In the locked orientation, the locking block 186 is in the extended position as it is in the intermediate orientation, and the top platen assembly 122 is raised slightly compared to a position of the top platen assembly 122 in the intermediate orientation as suggested in FIG. 17B as compared to FIG. 17A. The raised top platen assembly 122 engages the locking block 186 and slides the locking block 186 upwards toward the upper support plate 183. In the locked orientation, the raised position of the top platen assembly 122 and the locking block 186 closes the gaps above and below the locking block 186 and cause the locking block 186 to engage the top platen assembly 122 and compression head frame 130 to block the top platen assembly from moving (via the moving frame actuator unit 124 or by reaction forces generated and/or experienced during compression cycle as discussed below.) relative to the to the compression head frame 130. The locked orientation maintains the top platen assembly 122 in place during the cooking step 40 and resists the upward force caused by the top actuator 154 pushing the top punches 219 into compression against the raw ingredients 12 and the bottom punches 218.

In the unlocked orientation, the locking block 186 is in the retracted position, removed from the space between the upper plate 157 of the top platen assembly 122 and the upper support plate 183 of the compression head frame 130. In the unlocked orientation, the locking block 186 is spaced apart or otherwise not engaged with the top platen assembly 122 to allow the top platen assembly 122 to be moved by the moving frame actuator unit 124 as suggested in FIGS. 22 and 23. As such, the top platen assembly 122 may be moved away from the bottom platen assembly 120 during the cleaning step 60.

During dosing or feeding of a compression head assembly 114, the compression head assembly 114 is in the locked orientation with the top platen assembly 122 in a lowered position, the locking block 186 is in the extended position, and the bottom punch assembly 200 and top punch assembly 201 are spaced apart so that the gap 172 is unobstructed as depicted in FIGS. 1 and 9A. The feed system moves into the gap 172 and doses a predetermined amount of raw ingredients 12 into each of the bottom ring holes 142 and then moves out of the gap 172. A controller may instruct the respective actuators to position the top platen assemblies 122, the punch assemblies 200, 201, and/or the moving frame 180 into corresponding feed mode positions. Alternatively, the compression head assembly 114 may not be in the locked orientation during dosing and feeding. In some embodiments, the compression head assembly 114 may be in the unlocked orientation up until the start of the cook step. The compression head assembly 114 may be moved into the locked orientation concurrently with the dosing and/or feeding steps, or after the feeding step but before the cooking step.

For the cooking step of a compression head assembly 114, the compression head assembly 114 is in the locked orientation with the top platen assembly 122 in a lowered position, the locking block 186 is in the extended position, and the bottom punch assembly 200 and top punch assembly 201 are moved toward each other as depicted in FIG. 10. The controller may instruct the respective actuators to position the top platen assemblies 122, the punch assemblies 200, 201, and/or the moving frame 180 into corresponding cook mode positions. In particular, the moving frame actuator 180 is retracted so that the top platen assembly 122 is in the lowered position. In the illustrative embodiment, the top platen assembly 122 is engaged with the platen stop 182. The lock actuator 188 is extend so that the locking block 186 is in the extended position, and the compression head assembly 114 is in the locked orientation with the locking block 186 engaged with the upper plate 157 of the moving frame 150 and the cover plate 183 of the compression head frame 130. The location at which the locking block 186 contacts the moving frame 150 may be referred to as the engagement location. In the illustrative embodiment, the engagement location is disposed on an upper surface of the upper plate 157, where locking block 186 contacts the upper plate 157 as shown in FIG. 21. Movement of the moving frame 150 relative to the compression head frame 130 is blocked during the cooking step 40.

The top actuator 154 extends to cause the top punches 219 to extend through the top ring plate 160 and into the bottom ring holes 142. The bottom actuator 134 extends to move the bottom punches 218 toward the top punches 219, but keeping cooking surfaces 228′ of the bottom punches within the bottom ring holes 142 so that the raw ingredients 12 remains in the bottom ring holes 142. As a result, the raw ingredients 12 are compressed and heated in each bottom ring hole 142 of the bottom ring plate 140 between a bottom punch 218 and a top punch 219 to cook the raw ingredients 12 into the food product 14. The top actuator 154 and bottom actuator 134 may be programmed with any suitable combination movement or timing instructions to cause the top punches 219 and bottom punches 218 to compress and heat the raw ingredients 12.

The raw ingredients 12 are compressed by moving either or both the plurality of bottom punches 218 relative to the compression head frame 130 and the plurality of top punches 219 relative to the moving frame 150. The plurality of top punches 219 are translated in the corresponding plurality of top ring holes 162 formed in the top ring plate 160 and into the plurality of bottom ring holes 142 formed in the bottom ring plate 140. In some embodiments, the top ring plate 160 is omitted. The plurality of bottom punches 218 are translated partway into the plurality of bottom ring holes 142. The raw ingredients 12 are cooked with the bottom punches 218 and the top punches 219 while the raw ingredients 12 are compressed, contained, released (and any suitable combinations thereof) to provide the food product 14. As discussed above, a single bottom punch 218 and a single top punch 219 may be used in the compression head assembly 114 to form a single food product 14.

The controller may instruct the bottom actuator 134 and the top actuator 154 to retract and extend one or more times over preset periods of time to obtain a desired cook time, internal temperature, surface texture, etc. of the food product 14. To give some examples, during portions of the cook cycle the raw ingredients 12 may be compressed (i.e. force applied by the punches 218, 219 to the raw ingredients 12), contained (i.e. punches 218, 219 are held in position and resisting the vapor pressure inside the cook chamber from the steam generated by heating the raw ingredients 12 without applying compressive force to the raw ingredients 12), or released (i.e. punches 218, 219 move away from the raw ingredients 12 to increase the volume of the cooking chamber to allow the raw ingredients 12 to expand and/or allowing more volume for superheated liquid water in the raw ingredients 12 to change phase into steam). In some embodiments, the bottom actuator 134 does not move during the cooking step 40 and remains at least partially retracted. In some embodiments, the bottom punches 218 and the top punches 219 are maintained within the bottom ring holes 142. In some embodiments, either or both the bottom punches 218 and the top punches 219 are allowed to move outside of the bottom ring holes 142.

According to embodiments of the present disclosure, the raw ingredients 12 may be or include one or more of the following: wheat, rye, maize (corn), rice, sago, sorghum, triticale, millet, beans, potatoes, or starches from these or similar sources. According to other embodiments, the raw ingredients may alternatively or additionally include protein-rich food materials or protein therefrom. Other alternative ingredients may include one or more of the following: whole pieces of beans and peas, such as green and yellow peas, black bean, garbanzo bean, chick peas; whole seeds, such as sesame, quinoa, and chia; extruded pellets, such as soy-based protein pellets, pellets containing dried fruits, and vegetable pellets made from spinach, carrots, or beet etc.

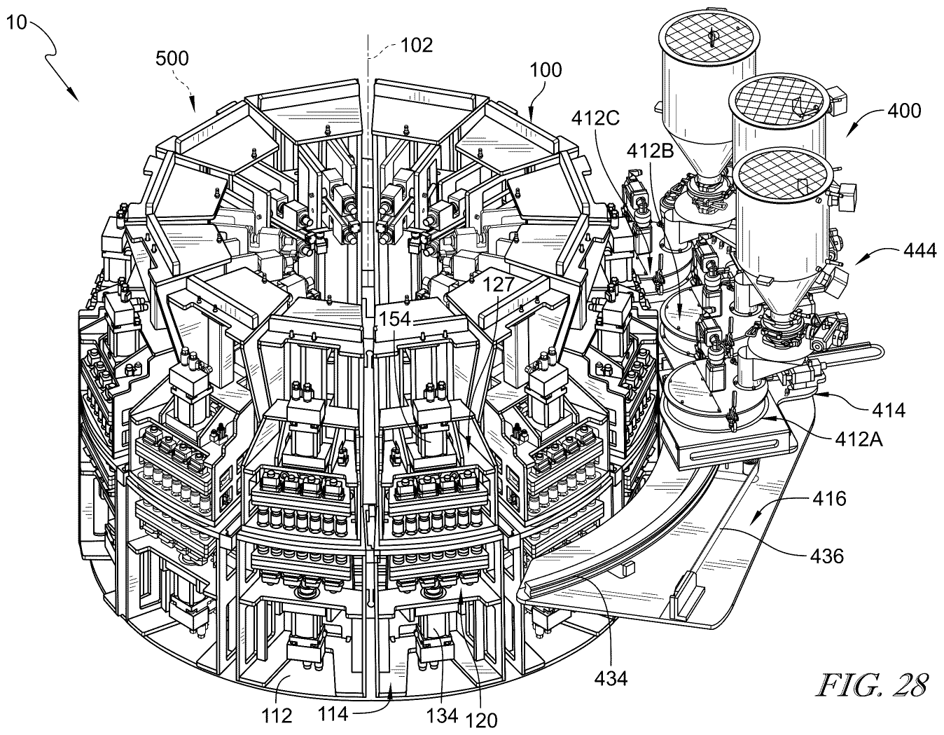

FIG. 28 depicts a perspective view of an apparatus 10 utilizing the compression head assembly 114 of FIG. 1 for making food product 14 that is expanded or popped (chips, puffs, etc.) as part of the cooking process. In other embodiments, the apparatus 10 may be used to make products, for example, non-food products, with materials such as metal, plastic, or other similar materials. In other embodiments, the apparatus 10 may be used for different types of forming methods for products that are, for example, extruded, pressure formed, or other similar forming or manufacturing methods. In some embodiments, the apparatus includes a single compression head assembly 114 and, in some embodiments, the apparatus 10 includes a plurality of compression head assemblies 114.

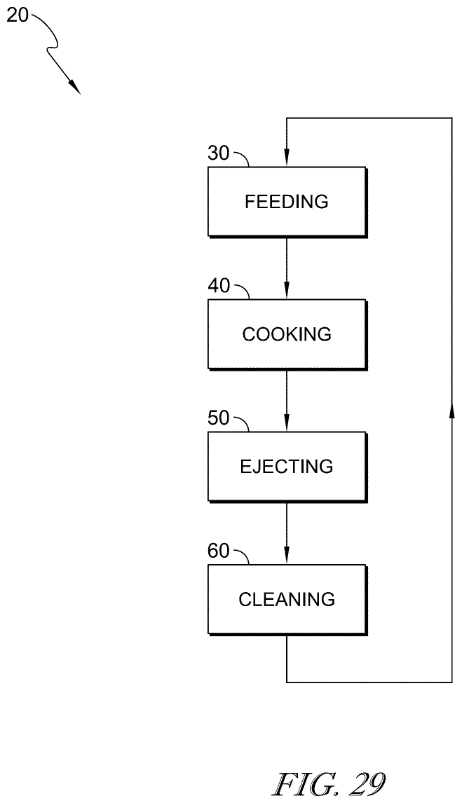

A process 20 is described in the present disclosure with the apparatus 10; though it will be appreciated that variations of the apparatus 10 as well as other equipment may be used in the process 20. Reference is hereby made to U.S. provisional application Ser. No. 63/646,240, filed May 13, 2024 and titled APPARATUS AND METHODS FOR MAKING EXPANDED FOOD PRODUCT, and to U.S. provisional application Ser. No. 63/771,145, filed Mar. 13, 2025 and titled APPARATUS AND METHODS FOR MAKING EXPANDED FOOD PRODUCT, for relating to a method of using the compression head assembly 114 and manufacturing products, which applications are hereby incorporated in their entirety. As depicted in FIG. 29, the process 20 comprises a feeding step 30, a cooking step 40, a food removal or ejection step 50, and a cleaning step 60. The apparatus 10 allows the process 20 to operate continuously, without interruption, which may allow for more food product 14 to be produced in a given amount of time and reduce or eliminate downtime for maintenance and cleaning. The cleaning step 60 and/or components may be optionally omitted in some embodiments.

As depicted in FIG. 28, the apparatus 10 comprises a carriage system 100, a feed system 400, and an ejection and cleaning system 500 in the illustrative embodiment. The carriage system 100 compresses, cooks, and expands raw ingredients 12 to provide expanded food product 14 in the cooking step 40. The feed system 400 delivers the raw ingredients 12 to the carriage system 100 during the feeding step 30 of the process 20. The ejection and cleaning system 500 move the expanded food product 14 away from the carriage system 100 in the ejection step 50 and clean the carriage system 100 in the cleaning step 60.

As depicted in FIG. 28, the carriage system 100 includes at least one compression head assembly 114 (the carriage system 100 shown and described includes a plurality of compression head assemblies 114) configured to compress and the heat the raw ingredients 12 to provide the expanded food product 14 and a moving base 112 coupled with the plurality of compression head assemblies 114. The moving base 112 moves the at least one compression head assembly 114 along a carriage path 16 to facilitate the continuous process 20. In other embodiments, the moving base 112 is omitted and the at least one compression head assembly 114 is stationary relative to ground. Each compression head assembly 114 is adapted to receive the raw ingredients 12 from the feed system 400 and to compress, cook, and allow expansion of the raw ingredients 12 in the cooking step 40 to provide the expanded food product 14. The carriage path 16 may form a closed loop or path of motion. In the illustrative embodiment, the carriage path 16 is a looped path. In the illustrative example, the looped path is a circular path that extends around an axis 102 extending vertical relative to ground. In other embodiments, the carriage path 16 is a closed path of motion (looped path) having any suitable shape including symmetrical and asymmetrical paths.

As suggested in FIG. 28, the feed system 400 meters and delivers the raw ingredients 12 to the compression head assemblies 114 as the compression head assemblies 114 move along the carriage path 16. The feed system 400 includes at least one feed assembly 412, at least one storage container assembly 444, a moving frame 414, and a base 416 as depicted in FIG. 28. The at least one feed assembly 412 includes a first feed assembly 412A, a second feed assembly 412B, and a third feed assembly 412C in some embodiments. In other embodiments, one, two, or any number of feed assemblies 412 may be used. The feed assemblies 412 are each configured to provide doses of a predetermined volume of the raw ingredients 12 and to deliver the doses to one of the compression head assemblies 114 as that compression head assembly 114 travels along the carriage path 16.

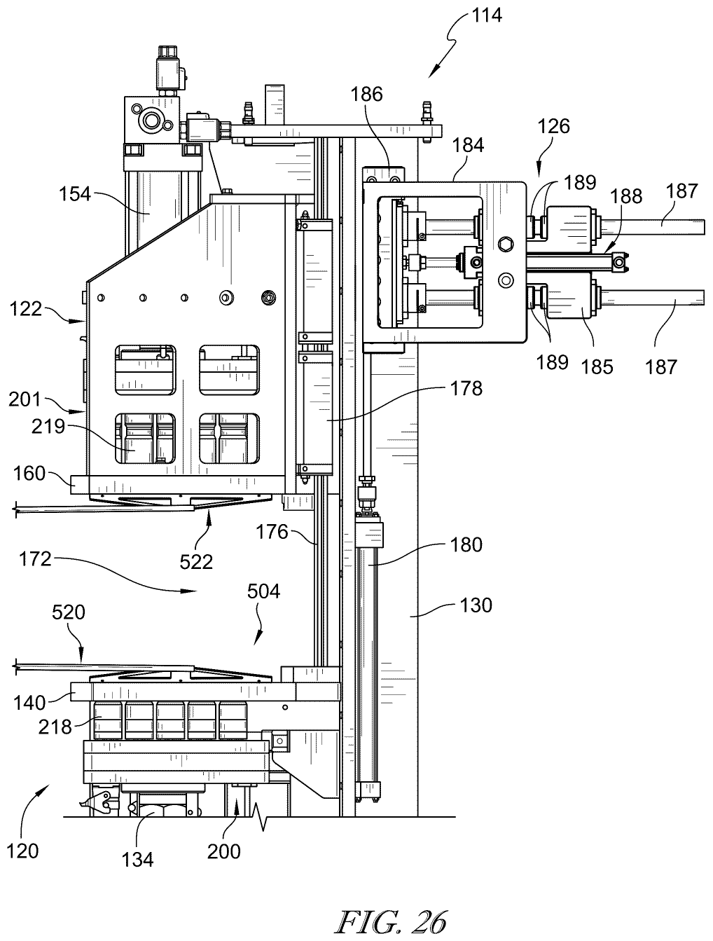

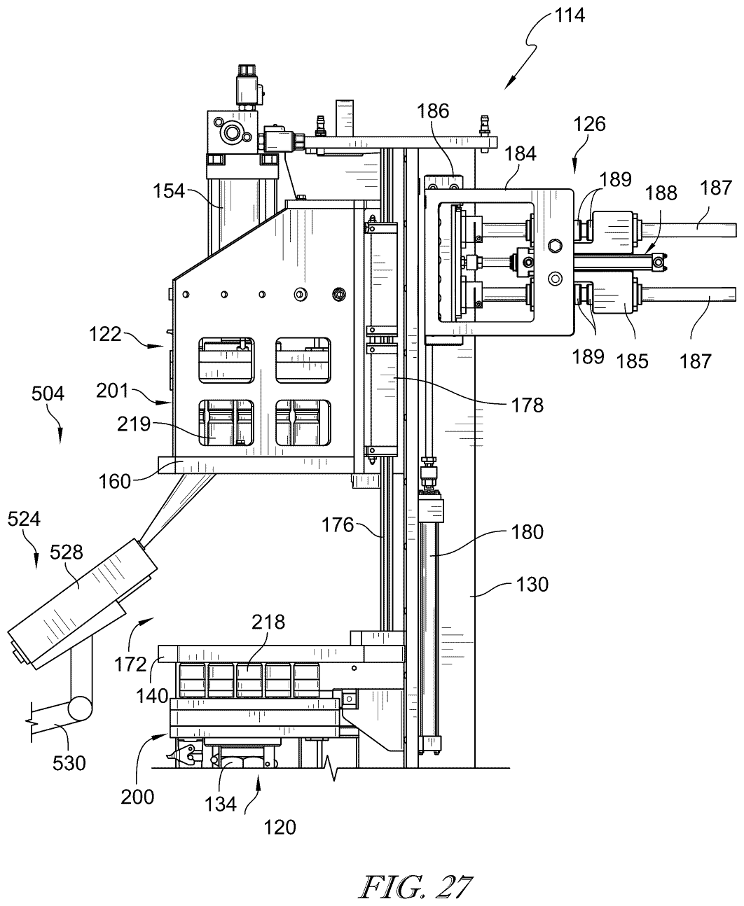

The ejection and cleaning system 500 includes the ejection assembly and the cleaning assembly 504, at least a portion of which is depicted in FIGS. 26-27. The ejection assembly is located downstream of the feed system 400 and removes completed product from the compression head assemblies 114. The ejection system may include a reciprocating arm, air blower, or any other suitable alternative for moving the product away from the compression head assembly 114. The cleaning assembly 504 is located directly upstream of the feed system 400 in the illustrative embodiment. The wipers 520, 522 are coupled with the frame 501 and are stationary relative to the rotating compression head assemblies 114. The wipers 520, 522 engage surfaces of the compression head assemblies 114 as the compression head assemblies 114 rotate past the wipers 520, 522 along the carriage path. The laser head unit 524 directs a laser beam (directed energy) at the compression head assemblies 114 to burn off the remnants of raw ingredients 12, food product 14, or other food debris. In embodiments with the locking assembly 126, the top platen assembly 122 is moved to the raised position for the cleaning step 60 to allow for maximum space for the wipers 520, 522 and the laser head unit 524. In embodiments without a moving top platen assembly 122, the wipers 520, 522 and the laser head unit 524 may operate in a smaller gap 172.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

As used in this application, “upstream” and “downstream” refer to locations of objects relative to a location of another object with respect to the process direction, where “downstream” refers to the direction of flow of the materials to be processed through the described apparatus.

As used in this application, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values include, consist essentially, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used in this application have the same meaning as is commonly understood by one of ordinary skill in the art to which this disclosure belongs. The terms “first”, “second”, “third”, and the like, as used herein do not denote any order or importance, but rather are used to distinguish one element from another. The term “or” and “and/or” is meant to be inclusive and mean either, all, or any combination of the listed items. In addition, the terms “connected” and “coupled” are not restricted to physical or mechanical connections or couplings, and can include electrical connections or couplings, whether direct or indirect. Direct connection and/or coupling can include such connections and/or couplings where no intermittent connection or component is present between two endpoints, components or items. Indirect connection and/or coupling can include where there is one or more intermittent or intervening connections and/or couplings present between respective endpoints, components or items.

Approximating language, as used in this application throughout the specification and claims, may be applied to modify any quantitative representation that could permissibly vary without resulting in a change in the basic function to which it is related. Accordingly, a value modified by a term or terms, such as “about,” “substantially,” or “essentially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used in this application, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

While only certain features of the described apparatus have been illustrated and described in this application, many modifications and changes will occur to those skilled in the art. It is, therefore, to be understood that the appended claims are intended to cover all such modifications and changes that fall within the true spirit of the invention.

1. A compression head assembly for making a compressed product, the compression head assembly comprising:
a first platen assembly that includes a first frame and a first punch assembly having a first punch to compress and heat raw ingredients;
a first actuator coupled with the first frame and the first punch assembly to move selectively the first punch assembly relative to the first frame; and
a first collar assembly coupled with the first actuator to stop the first actuator from moving the first punch assembly past a first predetermined location relative to the first platen assembly.

2. The compression head assembly of claim 1, wherein the first frame includes a support frame and a first ring plate coupled with the support frame, the first frame houses the first punch assembly and is coupled with the first actuator to allow the first actuator to move the first punch assembly relative to the first ring plate, wherein the first predetermined location corresponds to an outer surface of the first ring plate.

3. The compression head assembly of claim 2, wherein the first collar assembly is coupled to the first actuator to stop the first actuator from retracting the first punch assembly past the outer surface of the first ring plate.

4. The compression head assembly of claim 2, wherein the first ring plate includes a first ring hole that receives the first punch therein to guide movement of the first punch as the first actuator moves the first punch assembly, the first predetermined location corresponding to a position of the first punch assembly where an end surface of the first punch is flush with the outer surface of the first ring plate.

5. The compression head assembly of claim 2, wherein the first ring plate includes a first ring hole that receives the first punch therein to guide movement of the first punch as the first actuator moves the first punch assembly, the first predetermined location corresponding to a location within the first ring plate to stop the first actuator from completely retracting the first punch from the first ring hole.

6. The compression head assembly of claim 5, wherein the first collar assembly is configured to set a depth of a cavity formed by the first ring plate and the first punch.

7. The compression head assembly of claim 1, further comprising
a second platen assembly that includes a moving frame coupled with the first frame and a second punch assembly having a second punch to compress and heat the raw ingredients, at least one of the first punch assembly being configured to move selectively relative to the first frame and/or the second punch assembly being configured to move selectively relative to the moving frame, and the second punch assembly and the first punch assembly being configured to compress and heat the raw ingredients therebetween to provide the compressed product;
and a moving frame actuator unit coupled with the first frame and the moving frame and configured to move selectively the moving frame relative to the first frame to cause the second platen assembly to move relative to the first platen assembly and increase accessibility for cleaning the first platen assembly and the second platen assembly;
a second actuator coupled with the moving frame and the second punch assembly to move selectively the second punch assembly relative to the moving frame; and
a second collar assembly coupled with the second actuator to stop the second actuator from moving the second punch assembly past a second predetermined location relative to the second platen assembly.

8. The compression head assembly of claim 7, wherein the first frame includes a support frame and a first ring plate coupled with the support frame, the first frame houses the first punch assembly and is coupled with the first actuator to allow the first actuator to move the first punch assembly relative to the first ring plate, the first predetermined location corresponding to a location within the first ring plate to stop the first actuator from completely retracting the first punch from a first ring hole that receives the first punch therein to guide movement of the first punch as the first actuator moves the first punch assembly.

9. The compression head assembly of claim 8, wherein the moving frame includes a second platen carriage and a second ring plate coupled with the second platen carriage, the second platen carriage houses the second punch assembly and is coupled with the second actuator to allow the second actuator to move the second punch assembly relative to the second platen carriage, and the second ring plate includes a second ring hole that receives the second punch therein to guide movement of the second punch as the second actuator moves the second punch assembly, the second predetermined location corresponding to location where an outer surface of the second punch assembly is flush with an outer surface of the second ring plate.

10. The compression head assembly of claim 9, wherein a cavity formed by the first ring plate and the first punch is configured to receive the raw ingredients compressed between the first punch and the second punch.

11. The compression head assembly of claim 9, wherein the second predetermined location is configured to position an outer surface of the second punch flush with a bottom surface of the second ring plate such that the second ring plate and the second punch form a continuous, flat surface.

12. The compression head assembly of claim 1, wherein the first collar assembly is configured to be removable from the first actuator to increase a maximum retraction distance of the first punch.

13. The compression head assembly of claim 1, wherein the first collar assembly is coupled to the first actuator such that a location of the first collar assembly on the first actuator can be adjusted to change the first predetermined location.

14. The compression head assembly claim 13, wherein the first collar assembly includes a collar and a locking nut, the locking nut coupled to the first actuator to change a distance between the first collar assembly and the first punch assembly to change the first predetermined location.

15. The compression head assembly of claim 9, further comprising a controller having a memory with instructions stored therein and at least one processor configured to perform the instructions, the controller is programmed to operate the compression head assembly in a clean mode in which the controller instructs the second actuator to move the second punch assembly such that the second punch extends into the second ring plate and the first actuator to move the first punch assembly such that the first punch extends into the first ring plate.

16. The compression head assembly of claim 15, wherein, in the clean mode, the second collar assembly causes a food contact surface of the second punch to be generally flush with a lower surface of the second ring plate.

17. The compression head assembly of claim 8, further comprising a controller having a memory with instructions stored therein and at least one processor configured to perform the instructions, the controller is programmed to operate the compression head assembly in a cook mode in which the controller instructs the second actuator to move the second punch assembly such that the second punch extends into the first ring plate and the first actuator to move the first punch assembly such that the first punch extends into the first ring plate to compress and heat the compressed product.

18. A method of operating a compression head assembly adapted to make a compressed product, the method comprising:
extending, via a first actuator, a first punch partway into a first ring hole
compressing raw ingredients by extending a second punch, via a second actuator, relative to a second platen frame towards the first punch and translating the second punch through a corresponding second ring hole formed in a second ring plate and into the first ring hole formed in a first ring plate;
cooking the raw ingredients with the first punch and the second punch while the raw ingredients are compressed to provide the compressed product; and
moving the second punch relative to the second ring plate a first predetermined distance set by a first collar assembly coupled to the second actuator such that a food contact surface of the second punch is generally flush with a surface of the second ring plate.

19. The method of claim 18 further comprising moving the first punch relative to the first ring plate a second predetermined distance set by a second collar assembly coupled with the first actuator such that an end surface of the first punch is flush with an outer surface of the first ring plate.

20. The method of claim 19 further comprising adjusting at least one of the first collar assembly relative to the first actuator to change the second predetermined distance and/or the second collar assembly relative to the second actuator to change the first predetermined distance.
